(19) United States
(12) Patent Application Publication
(10) Pub. No.: US 2005/0246684 A1
(43) Pub. Date: Nov. 3, 2005

(54) Image processing apparatus, image processing method, and computer product

(76) Inventor: Naoto Shiraishi, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/112,543

(22) Filed: Apr. 22, 2005

(30) Foreign Application Priority Data
Apr. 22, 2004 (JP) 2004-127194

(51) Int. Cl. G06F 9/44

(52) U.S. Cl. 717/115

(57) ABSTRACT

An intermediate-language creating unit analyzes a page description language to create an intermediate language having information of all CMYK printing versions. An intermediate-language storing unit stores the intermediate language created. A drawing-version setting unit sets each of the CMYK printing versions to be drawn with the intermediate language. An image-data creating unit analyzes the intermediate language stored to create image data for at least one printing version for creating the image data. An image-data storing unit stores the image data created. A drawing-version control unit recognizes the printing version to be drawn set by the drawing-version setting unit, and reads the intermediate language stored for a plurality of times.

The present application claims priority to and incorporates by reference the entire contents of Japanese priority document, 2004-127194 filed in Japan on Apr. 22, 2004.

### BACKGROUND OF THE INVENTION

1. Field of the Invention

The present invention relates to a technology for processing an image in an image forming apparatus, such as a color copying machine and a color printer.

2. Description of the Related Art

Conventionally, printers include an image processing apparatus that draws a page description language (PDL) received from a personal computer or the like via a network with multi-level red/green/blue (RGB) data in the unit of band, encodes it according to a compression algorithm (joint photographic experts group (JPEG) or the like) for multi-level images, stores a code thereof in a memory, and thereafter, at the time of printing, delays each printing version, to read the encoded data from the memory, decodes the encoded data to RGB data according to the compression algorithm, and thereafter, converts the RGB data to cyan/magenta/yellow/black (CMYK) data by color conversion processing, further converts the CMYK data to binary, four-valued, and eight-valued data by tone processing, and transfers to a printer engine only data corresponding to each printing of CMYK after the tone processing, to perform decoding exclusive for each printing and output processing exclusive for each printing.

The PDL is a printer control code (language) for creating a page image in a page printer. Furthermore, it often extends functions of graphic drawing and the like in addition to simple character printing. The representative examples of the PDL include PostScript, Hewlett-Packard Printer Control Language (HP-PCL), Legal Information Processing System (LIPS), Epson Standard Code/Page (ESC/page), and PRESCRIBE.

As the compression method, there is a method in which image data is transformed to frequency components by orthogonal transformation such as discrete cosine transform (DCT), and a transformation coefficient thereof is quantized, and as a method of encoding a multi-level image by using the DCT, a JPEG method is well known, which is an encoding standard for color still pictures by ITU-TI and International Organization for Standardization (ISO). The DCT operational expression is expressed as

$$Suv = \frac{{C ( u )}^{*} C ( v )}{4} {\sum }_{x = 0}^{7} {\sum }_{y = 0}^{7} {Syv}^{*} COS [ \frac{{( {2}^{*} x + 1 )}^{*} {u}^{*} π}{16} ] {}^{*} COS [ \frac{{( {2}^{*} y + 1 )}^{*} {v}^{*} π}{16} ]$$

DCT Equation

$$syx = \frac{1}{4} {\sum }_{x = 0}^{7} {\sum }_{y = 0}^{7} {C ( u )}^{*} {C ( v )}^{*} {Suv}^{*} COS [ \frac{{( {2}^{*} x + 1 )}^{*} {u}^{*} π}{16} ] {}^{*} COS [ \frac{{( {2}^{*} y + 1 )}^{*} {v}^{*} π}{16} ]$$

IDCT Equation
where u,v=0, 1,˜7, and

$$C ( W ) = ( \begin{matrix}\frac{1}{√ 2} & W = 0 \\ 1.0 & W = 1 , \sim 7\end{matrix} \qquad ( 1 )$$

Conventionally, a method is disclosed in which a PDL analyzer generates an intermediate language, a drawing controller receives the intermediate language and changes over two band buffers alternately, to perform drawing and transfer to an image output unit (for example, see Japanese Patent Application Laid-Open No. H8-276622).

In Japanese Patent Application Laid-Open No. H8-276622, since the drawing controller should complete drawing to the next band buffer within the time during which the image output unit performs printing, the banding width is changed according to the drawing time.

Recently, since tandem-type color printers that perform CMYK printing at the same time become popular, the drawing unit has to draw the CMYK printing versions simultaneously. When the drawing unit draws the CMYK printing versions simultaneously, the gate size of the drawing unit becomes too large, and it results in a cost increase. Therefore, conventionally, drawing processing is performed for each printing version.

Furthermore, a processing list to be processed by the drawing unit is created for each command of the respective CMYK printing versions, and a processing list address pointer for each printing version is included, to realize the drawing processing for each printing version (for example, see Japanese Patent Application Laid-Open No. 2002-259997).

FIG. 29 is a block diagram of a controller system of a conventional printer, and FIG. 30 is the processing timing thereof. In this system, a printer and a personal computer (PC) 200 are connected to a network 50. The printer includes a central processing unit (CPU) 51, a CPU interface (I/F) 52, a memory controller 53, a main memory 54, a drawing unit 55, an encoder 56, a decoder 57, an image processing. apparatus 58, an engine controller 59, a printer engine 60, a communication controller 61, a read only memory (ROM) 62, a local I/F 63, a panel controller 64, and an operation panel 65. As shown in FIG. 30, in such a system, the CPU 51 shown in FIG. 29 activates the drawing unit 55 by creating an intermediate language in the unit of band for the drawing unit 55, creates an intermediate language for the next band, and thereafter, activates the encoder 56 to encode an image of the generated band.

In Japanese Patent Application Laid-Open No. H8-276622, such a method is disclosed that since only two band buffers are used, and within the time of printing for a band, it is necessary to finish the drawing processing for the next band, the banding width is changed according to the drawing time, and learning is performed from the historical information in order to determine the banding width. However, it is difficult to accurately predict the drawing time for the band, and if the prediction is failed, a phenomenon occurs in which that band data cannot catch up printing, which is referred to a so-called overrun. Therefore, to avoid overrun, a large margin is provided to the predicted value, but in this case, idling occurs in the drawing processing, thereby causing a decrease in the printing speed. When creating the intermediate language in the unit of band, the PDL analyzer must control the processing time for creating the intermediate language by the PDL analyzer, in addition to the processing time for the drawing processing, thereby making the configuration and the processing complicated.

Furthermore, in Japanese Patent Application Laid-Open No. H8-276622, it is considered that the intermediate language is created in the unit of page. When the intermediate language is created in the unit of page, the drawing processing cannot be started until the intermediate language for one page has been created. Therefore, the time until the printing time of the first page increases.

In Japanese Patent Application Laid-Open No. 2002-259997, in order to draw the CMYK printing versions for each version, a CPU must generate a command for each version and activate the drawing unit. Therefore, WAIT processing (waiting time) is necessary as long as four times the case when the CMYK printing versions are simultaneously drawn. Furthermore, at the time of creating the intermediate language, the PDL is sequentially analyzed and created. When a command is generated for each CMYK printing version, the same PDL must be analyzed and created, thereby causing a. problem in that the processing speed becomes slower.

On the other hand, as shown in FIG. 30, the drawing processing 55 for band 2 by the conventional drawing unit overlaps on the encoding processing for band 1 by the encoder 56, and contention of the main memory 54 among the CPU 51, the drawing unit 55, and the encoder 56, and according to the circumstances, the decoder 57 occurs frequently, thereby deteriorating the system efficiency. Particularly, since the drawing unit 55 accesses the band memory at a high speed, when memory contention occurs with other direct memory access (DMA) apparatuses and the like, the idle time for reconciliation increases, thereby deteriorating the efficiency.

### SUMMARY OF THE INVENTION

An image processing apparatus, image processing method, and computer product. In one embodiment, the image processing apparatus comprises an intermediate-language creating unit that analyzes a page description language to create an intermediate language having information of all CMYK printing versions, an intermediate-language storing unit that stores the intermediate language created, a drawing-version setting unit that sets each of the CMYK printing versions to be drawn with the intermediate language, image-data creating unit that analyzes the intermediate language stored to create image data for at least one printing version for creating the image data, an image-data storing unit that stores the image data created, and a drawing-version control unit that recognizes the printing version to be drawn set by the drawing-version setting unit, and reads the intermediate language stored for a plurality of times.

### BRIEF DESCRIPTION OF THE DRAWINGS

FIG. 1 is a schematic for illustrating a configuration example of a mechanism unit of an image forming apparatus according to a first embodiment of the present invention;

FIG. 2 is a block diagram of a configuration of a transmission controller of a color printer shown in FIG. 1;

FIG. 3 is a block diagram of a flow in an image processing according to the first embodiment;

FIG. 4 is a block diagram of an overview of the image processing according to the first embodiment;

FIG. 5 is a schematic for illustrating a format example of a main memory shown in FIG. 2;

FIG. 6 is a schematic for illustrating an example of an intermediate language stored in an intermediate language memory 104b shown in FIG. 5;

FIG. 7 is a schematic for illustrating a drawing command format example according to the present embodiment;

FIG. 8 is a schematic for illustrating a drawing example of a band in the intermediate language shown in FIG. 6;

FIG. 9 is a timing chart for generation of an intermediate language by a CPU and parallel processing of a drawing unit and an encoder shown in FIG. 4;

FIG. 10 is a flowchart of control operation of the CPU according to the first embodiment;

FIG. 11 is a block diagram of the detailed configuration of the drawing unit according to the first embodiment;

FIG. 12 is a block diagram of the detailed configuration of a drawing-command-address generating unit shown in FIG. 11;

FIG. 13 is a flowchart of the processing operation of the drawing unit according to the first embodiment;

FIG. 14 is a block diagram of the detailed configuration of the encoder shown in FIG. 2;

FIG. 15 is a block diagram of the detailed configuration of a decoder shown in FIG. 2;

FIG. 16 is a block diagram of the detailed configuration of an image processing apparatus shown in FIG. 2;

FIG. 17 is a block diagram of the configuration of a transmission controller according to a second embodiment of the present invention;

FIG. 18 is a block diagram of the concept of an image processing according to the second embodiment;

FIG. 19 is a timing chart for the operation of generating an intermediate language and the drawing processing according to the second embodiment;

FIG. 20 is a block diagram of the detailed configuration of the drawing unit according to the second embodiment;

FIG. 21 is a block diagram of the detailed configuration of the image forming apparatus according to the second embodiment;

FIG. 22 is a flowchart of the processing operation of the image forming apparatus shown in FIG. 21;

FIG. 23 is a block diagram of the configuration of another transmission controller according to the second embodiment;

FIG. 24 is a schematic for illustrating a format example of the intermediate language processed by the drawing unit shown in FIG. 23;

FIG. 25 is a block diagram of the detailed configuration of the drawing unit shown in FIG. 23;

FIG. 26 is a block diagram of the detailed configuration of an encoding processing unit shown in FIG. 25;

FIG. 27 is a block diagram of an example of a computer to execute the image processing method according to an embodiment;

FIG. 28 is a block diagram of an example in which the image processing method according to the present embodiment is downloaded from a network and executed;

FIG. 29 is a block diagram of the configuration of a controller system of a conventional printer; and

FIG. 30 is a timing chart for intermediate language creation processing and drawing processing in the conventional system shown in FIG. 29.

### DETAILED DESCRIPTION

Embodiments of the present invention solve at least the above problems in the conventional technology.

An image processing apparatus according to one embodiment of the present invention includes an intermediate-language creating unit that analyzes a page description language to create an intermediate language having information of all CMYK printing versions; an intermediate-language storing unit that stores the intermediate language created; a drawing-version setting unit that sets each of the CMYK printing versions to be drawn with the intermediate language; an image-data creating unit that analyzes the intermediate language stored to create image data for at least one printing version for creating the image data; an image-data storing unit that stores the image data created; and a drawing-version control unit that recognizes the printing version to be drawn set by the drawing-version setting unit, and reads the intermediate language stored for a plurality of times.

An image processing apparatus according to another embodiment of the present invention includes an intermediate-language creating unit that analyzes a page description language to create an intermediate language in the unit of band or in the unit of page; an intermediate-language storing unit that stores the intermediate language created; an image-data creating unit that analyzes the intermediate language stored to create image data for at least one printing version for creating the image data in the unit of band or in the unit of page; an image-data storing unit that stores the image data created; an image-data encoding unit that encodes the image data stored in the unit of band or in the unit of page to create an image-data code; an image-data-code storing unit that stores the image-data code created; an image-data decoding unit that decodes the image-data code stored; a drawing-state storing unit that informs the intermediate-language creating unit of a drawing state, the drawing state including an active state in which drawing is being carried out and a suspended state in which the drawing is being suspended; and a parallel-operation control unit that obtains a state of the image-data creating unit from the drawing-state storing unit to control a parallel operation of the intermediate-language creating unit and the image-data creating unit.

An image processing method according to still another embodiment of the present invention includes analyzing a page description language to create an intermediate language having information of all CMYK printing versions; storing the intermediate language created; setting each of the CMYK printing versions to be drawn with the intermediate language; analyzing the intermediate language stored to create image data for at least one printing version for creating the image data; storing the image data created; recognizing the printing version to be drawn set; and reading the intermediate language stored for a plurality of times.

An image processing apparatus according to still another embodiment of the present invention includes an intermediate-language creating unit that analyzes a page description language to create an intermediate language; an intermediate-language storing unit that stores the intermediate language created; an image-data creating unit that analyzes the intermediate language stored to create image data; an image-data storing unit that stores the image data created; an encoding unit that encodes the image data stored to create an image code; an image-code storing unit that stores the image code created; and a processing control unit that recognizes a completion of processing of the image-data creating unit, and activates the encoding unit.

An image processing apparatus according to still another embodiment of the present invention includes an intermediate-language creating unit that analyzes a page description language to create an intermediate language; an intermediate-language storing unit that stores the intermediate language created; an image processing unit that analyzes the intermediate language stored to create image data, and encodes the image data to create an image code; an image-data storing unit that stores the image data created; and an image-code storing unit that stores the image code created.

An image processing method according to still another embodiment of the present invention includes analyzing a page description language to create an intermediate language; storing the intermediate language created; analyzing the intermediate language stored to create image data; storing the image data created; encoding the image data stored to create an image code; storing the image code created; recognizing a completion of processing of the analyzing the intermediate language stored; and activating the encoding.

A computer-readable recording medium according to still another embodiment of the present invention stores a computer program that causes a computer to execute the above image processing methods according to the present invention.

Exemplary embodiments of an image processing apparatus, an image processing method, and a computer product according to embodiments of the present invention will be explained in detail with reference to the accompanying drawings.

Embodiments of the present invention realize speed-up by realizing pipeline processing having large parallelism. Furthermore, embodiments of the present invention exclude concerns about occurrence of overrun, since printing is started after a page code is generated in the unit of page. The present invention will be specifically explained below.

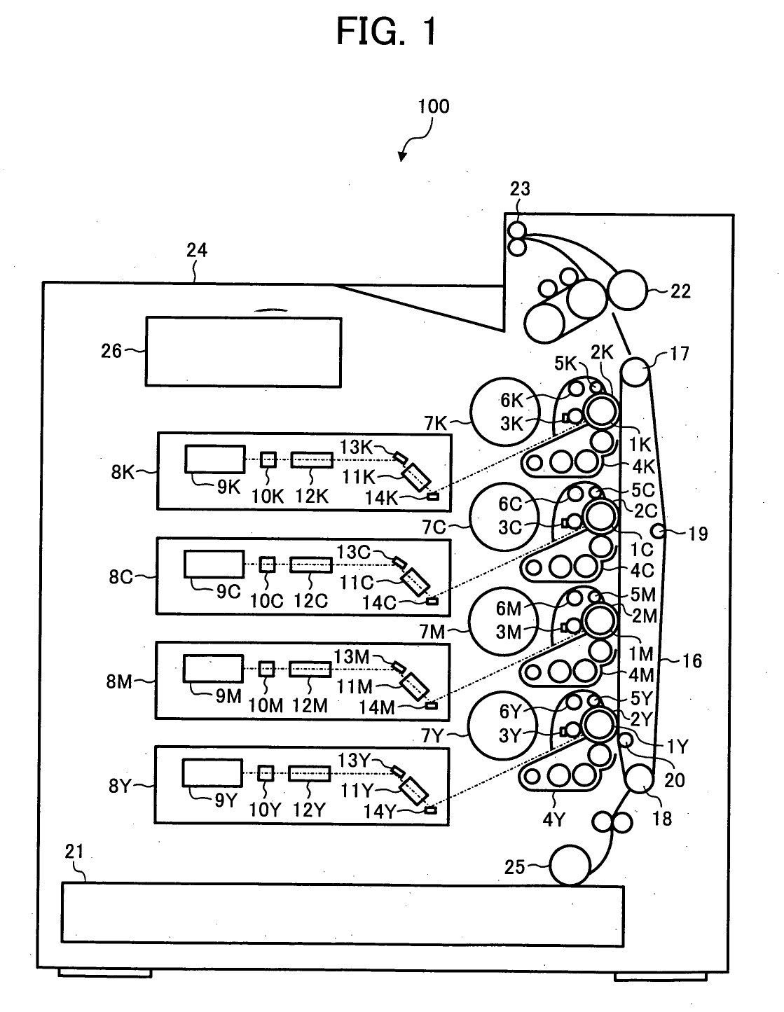

The configuration and the operation of an image forming apparatus (printer) in which an image processing apparatus according to the present invention is installed will be explained. FIG. 1 is a schematic for illustrating a configuration example of a mechanism unit of an image forming apparatus according to a first embodiment of the present invention. Hereinafter, the image forming apparatus shown in FIG. 1 is described as a color printer. A laser color printer will be explained as an example in this embodiment, but other color printers such as an inkjet printer can be used.

A color printer 100 shown in FIG. 1 is a four-drum tandem engine-type image forming apparatus in which four color (yellow (Y), magenta (M), cyan (C), and black (B)) images are respectively formed by imaging systems 1Y, 1M, 1C, and 1K arranged independently, according to a laser beam writing and an electrophotographic process, and the four color images are sequentially superposed and transferred onto recording paper and synthesized.

Respective imaging systems 1Y, 1M, 1C, and 1K include a photosensitive member as an image carrier, for example, organic photosensitive drums (OPC) 2Y, 2M, 2C, and 2K of a small diameter, and charging rollers 3Y, 3M, 3C, and 3K as charging means, developing apparatuses 4Y, 4M, 4C, and 4K that respectively develop an electrostatic latent image on the OPC drums 2Y, 2M, 2C, and 2K by a developer to form toner images of respective Y, M, C, and K colors, cleaning apparatuses 5Y, 5M, 5C, and 5K, and discharging devices 6Y, 6M, 6C, and 6K, and the like are arranged so as to surround the OPC drums 2Y, 2M, 2C, and 2K, in order of from the upstream side of imaging.

Toner bottle units 7Y, 7M, 7C, and 7K that respectively supply a predetermined color toner of Y toner, M toner, C toner, and K toner to the developing apparatuses 4Y, 4M, 4C and 4K are arranged on the side of respective developing apparatuses 4Y, 4M, 4C, and 4K. Optical write units 8Y, 8M, 8C, and 8K by lasers independently arranged are arranged in the respective imaging systems 1Y, 1M, 1C, and 1K, and the imaging systems 1Y, 1M, 1C, and 1K include laser diode (LD) light sources 9Y, 9M, 9C, and 9K as a laser light source, optical components such as collimate lenses 10Y, 10M, 10C, and 10K and fθ lenses 11Y, 11M, 11C, and 11K, polygon mirrors 12Y, 12M, 12C, and 12K as a deflection scanning unit, and folding mirrors 13Y, 13M, 13C, and 13K, and the like.

The respective imaging systems 1Y, 1M, 1C, and 1K are vertically arranged, and a transfer belt unit 15 is arranged on the right side of thereof, abutting against the OPC drums 2Y, 2M, 2C, and 2K. The transfer belt unit 15 is rotated by a drive source (not shown) with a transfer belt 16 laid across rollers 17 to 20 in a tensioned condition. A paper feed tray 21 in which the recording paper as a transfer material is stored is arranged in the lower part of the apparatus, and a fixing apparatus 22 having a thermal fixing roller and a pressure roller, a paper ejection roller 23, and a paper ejection tray 24 are set in the upper part of the apparatus.

At the time of imaging, in the respective imaging systems 1Y, 1M, 1C, and 1K, the OPC drums 2Y, 2M, 2C, and 2K are rotated by the drive source (not shown), and uniformly charged by the charging rollers 3Y, 3M, 3C, and 3K, and the optical write units 8Y, 8M, 8C, and 8K modulate the laser diode based on the respective color image data. The laser beams thereof are deflected to scan, to perform optical write on the OPC drums 2Y, 2M, 2C, and 2K, thereby forming an electrostatic latent image on the OPC drums 2Y, 2M, 2C, and 2K.

The electrostatic latent image on the OPC drums 2Y, 2M, 2C, and 2K is respectively developed by the developing apparatus 4Y, 4M, 4C, and 4K to turn into a toner image of the respective colors Y, M, C, and K. On the other hand, the transfer paper is horizontally fed by a feed roller 25 from the paper feed tray 21, and vertically transferred toward the imaging systems 1Y, 1M, 1C, and 1K by a transfer system. The recording paper is electrostatically attracted and held on the transfer belt 16 and carried by the transfer belt 16, a transfer bias is applied thereto by a transfer bias applying unit (not shown), and the toner images of the respective colors Y, M, C, and K on the OPC drums 2Y, 2M, 2C, and 2K are sequentially superposed on each other and transferred onto the recording paper, thereby forming a full color image on the recording paper. The full color image formed on the recording paper is fixed by the action of heat and pressure of the fixing apparatus 22 and ejected to the paper ejection tray 24 by the paper ejection roller 23. A transmission controller 26 that rotates the respective functional components to execute various kinds of image processing is installed in the image forming apparatus.

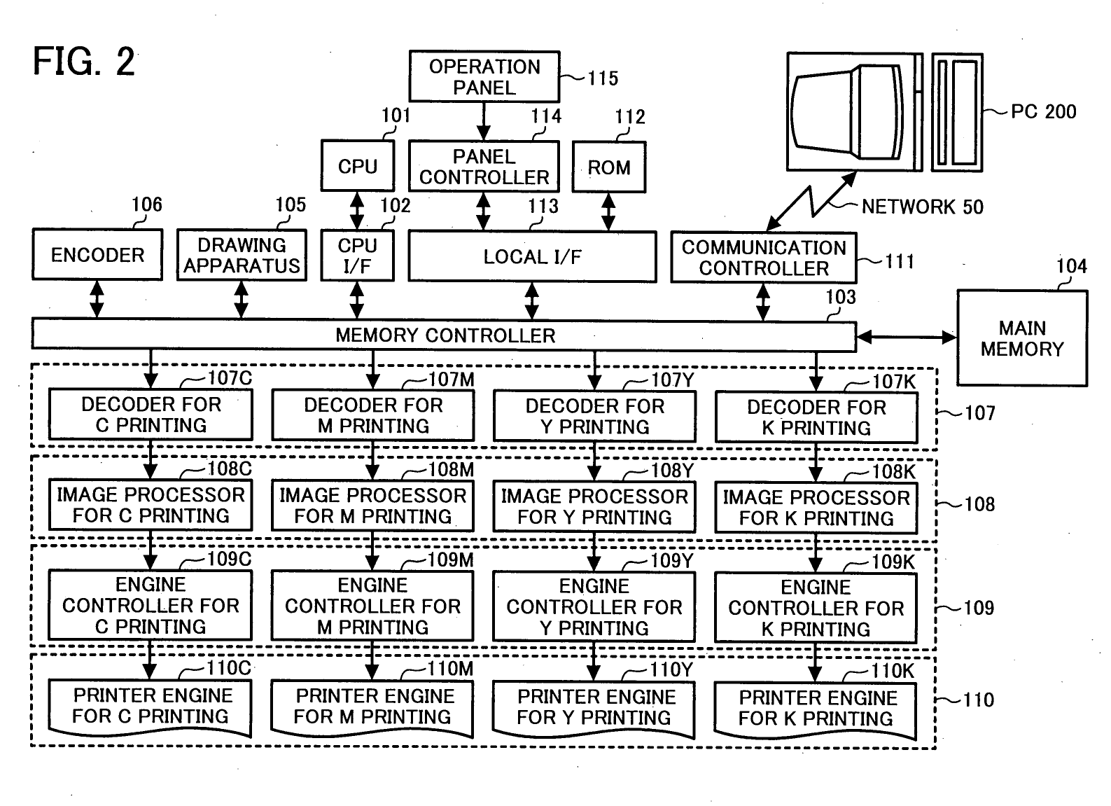

The detailed configuration and operation of the image processing apparatus in the color printer constructed in this manner will be explained. FIG. 2 is a block diagram of the configuration of the transmission controller 26 in the color printer shown in FIG. 1. The transmission controller 26 includes a CPU 101 that performs controlling the whole color printer (printer engine), a CPU I/F 102 connected to a memory controller 103 for executing interface control between the CPU 101 and the memory controller 103, the memory controller 103 that controls a main memory 104 and also controls transfer between a local bus of the CPU 101, a decoder, an encoder, a drawing unit, a communication controller, and the like and a main memory 104, the main memory 104 that stores images from the CPU 101, programs for the CPU 101, band data, and various kinds of data such as compression data of pages, a drawing unit 105 that receives a drawing command from the CPU 101 and draws the band of the main memory 104, an encoder 106 that encodes the band of the main memory 104, and transmits encoded data to a code page memory area in the main memory 104, a decoder 107 that receives the code encoded by the encoder 106, synchronized with the printer engine for each version, decodes the code and transmits the code to the respective image processing apparatus for each version, an image processing apparatus 108 that receives the decoded image data from the decoder for each version to perform image processing such as color conversion and tone processing for each version, and transfers the image data to an engine controller for each version, an engine controller 109 that receives the image from the image processing apparatus 108 and transfers the image to the printer engine, a printer engine 110, a communication controller 111 that receives PDL from a PC by a network 50 and transfers the PDL to the main memory 104, a local bus I/F 113 that executes interface control between a ROM and a panel controller, and the CPU 101 and the main memory 104, the ROM 112 that stores font information of character and the like, and programs for the CPU 101, the panel controller 114 that controls an operation panel 115, the operation panel 115 for informing the operation of a user to the printer, and a PC 200 that generates a PDL and transfers the PDL to the color printer via the network 50. The PC 200 creates an image file to be printed by the application software, and creates the PDL by the printer driver to transmit the image file and the PDL to the communication controller 111.

The decoder 107 includes a decoder 107C for C printing that performs decoding for C printing, a decoder 107M for M printing that performs decoding for M printing, a decoder 107Y for Y printing that performs decoding for Y printing, and a decoder 107K for K printing that performs decoding for K printing. The image processing apparatus 108 includes an image processing apparatus 108C for C printing that performs image processing for C printing, an image processing apparatus 108M for M printing that performs image processing for M printing, an image processing apparatus 108Y for Y printing that performs image processing for Y printing, and an image processing apparatus 108K for K printing that performs image processing for K printing. The engine controller 109 includes an engine controller 109C for C printing that performs the input and output control of the image data for C printing, an engine controller 109M for M printing that performs the input and output control of the image data for M, an engine controller 109Y for Y printing that performs the input and output control of the image data for Y printing, and an engine controller 109K for K printing that performs the input and output control of the image data for K printing. The printer engine 110 includes a printer engine 110C for C printing that forms the image data for C printing, a printer engine 110M for M printing that forms the image data for M printing, a printer engine 110Y for Y printing that forms the image data for Y printing, and a printer engine 110K for K printing that forms the image data for K printing.

The network 50 can be classified into a wide area network (WAN) for connecting to the outside via a public line or a private line, and a local area network (LAN) that forms a network in the same site, or can be either one thereof. When the Internet function is provided, the function can be a transmission control protocol/Internet protocol (TCP/IP), or it can be a connection by a wireless LAN.

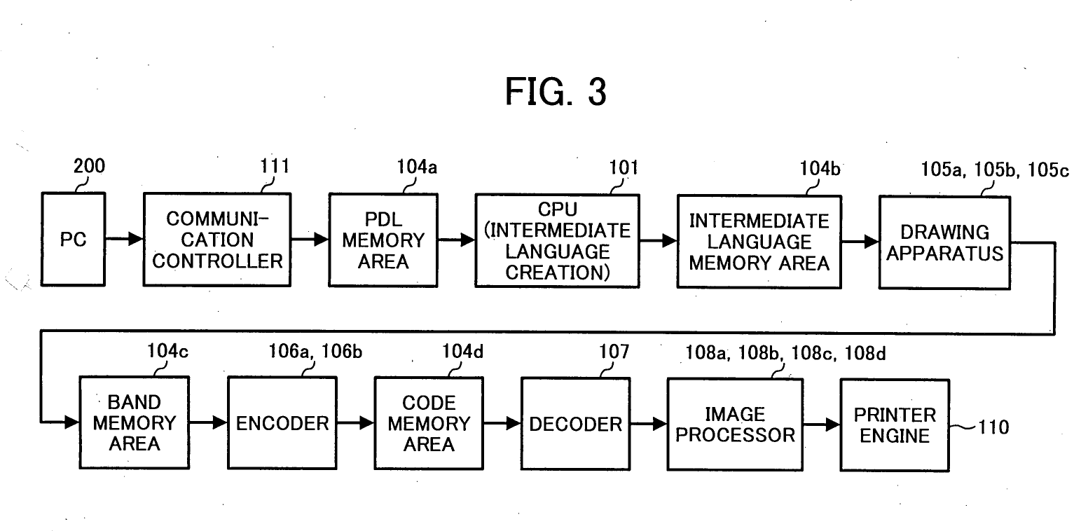

FIG. 3 is a block diagram of the flow in the image processing according to the first embodiment. In this figure, the PC 200 creates the PDL and transfers the PDL to the color printer via the network 50. The communication controller 111 receives the PDL from the PC 200 and transfers it to the PDL memory area 104a of the main memory 104. The PDL data from the communication controller 111 is stored in the PDL memory area 104a of the main memory 104. The CPU 101 analyzes the PDL in the PDL memory area 104a in the main memory 104, creates an intermediate language, and transmits the intermediate language to an intermediate language memory area 104b of the main memory 104. The intermediate language created by the CPU 101 is stored in the intermediate language memory area 104b of the main memory 104. The drawing unit 105 receives the intermediate language stored in the intermediate language memory area 104b of the main memory 104 and draws the band in a band memory area 104c of the main memory 104. The band data drawn by the drawing unit 105 is stored in the band memory area 104c of the main memory 104.

The encoder 106 reads and encodes the band data in the band memory area 104c of the main memory 104 and sends a code to a code page memory area 104d of the main memory 104. The code is received from the encoder 106 and stored in the code page memory area 104d of the main memory 104. The decoder 107 for each printing reads the code for one page including the codes for respective bands stored in the main memory 104, decodes the code, and transfers the code to the image processing apparatus 108 for each printing. The image processing apparatus 108 for each printing performs the image processing with respect to the received data and transfers the data to the engine controller 109 for each printing. The image data of the respective printing after the image processing is printed out by the printer engine 110.

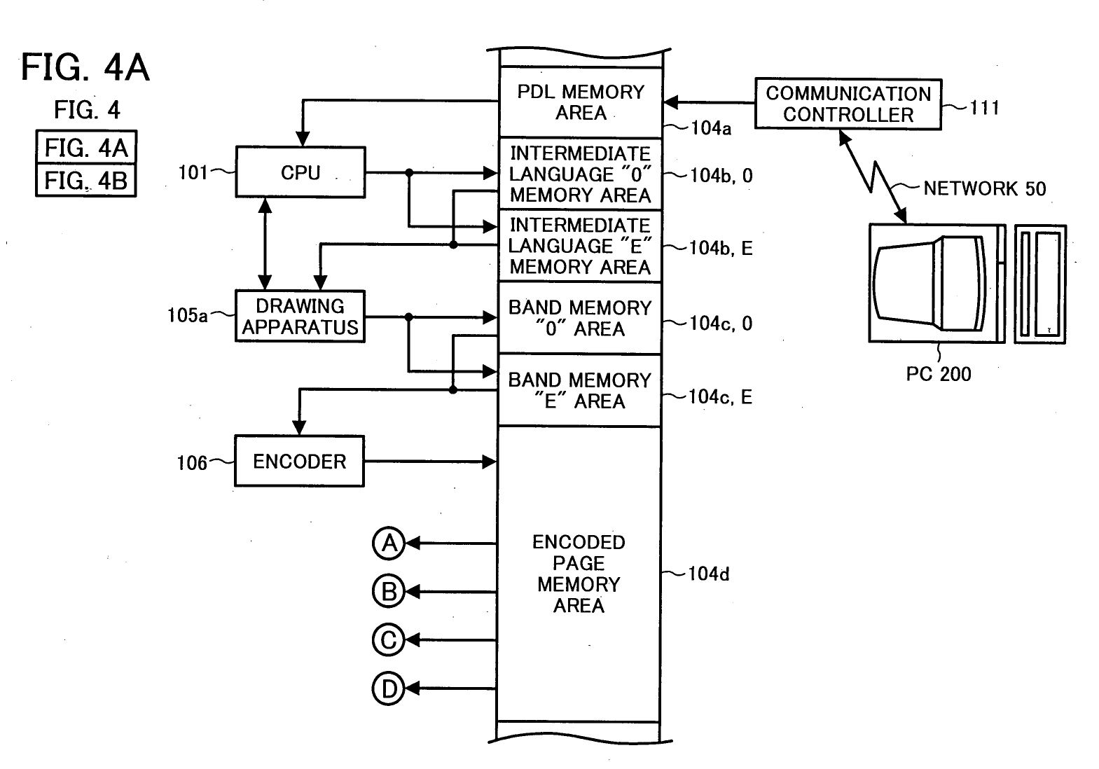

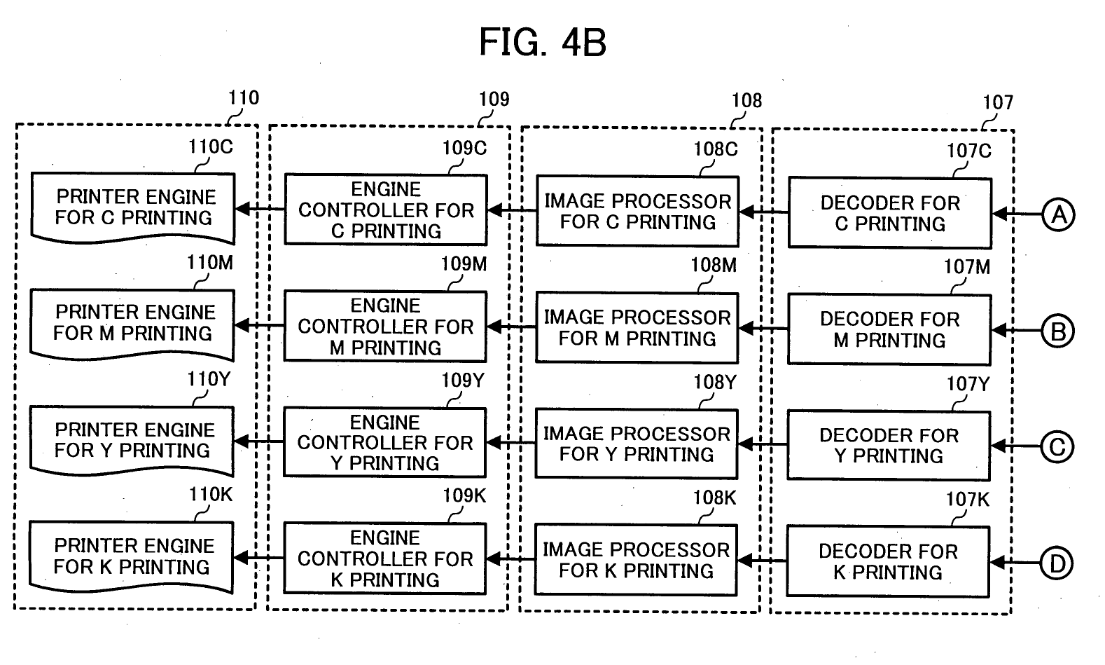

FIG. 4 is a block diagram of the overview of the image processing according to the first embodiment. In this figure, the PC 200 creates the PDL and transfers the PDL to the printer via the network 50. The communication controller 111 in the printer receives the PDL from the PC 200 and stores the PDL in the PDL memory area 104a of the main memory 104. The main memory 104 stores the PDL, the intermediate language, the band data, the page codes, programs, various kinds of work data, and the like. The CPU 101 analyzes the PDL from the PC 200 to create the intermediate language, and writes the intermediate language in an intermediate language “0” memory area 104b(0) and an intermediate language “E” memory area 104b(E) of the main memory 104.

The CPU 101 sets a start address of the intermediate language to be drawn in the drawing unit 105a, starts the drawing processing, reads a value of a status register in the drawing unit 105a, confirms the state of the drawing unit 105a, and performs the overall control. The drawing unit 105a starts the drawing processing according to the start-up command from the CPU 101, reads the intermediate language from the address in the main memory 104 of the intermediate language set by the CPU 101, analyzes the intermediate language, and draws the band in the band memory area 104c of the main memory 101. At this time, the drawing unit 105a informs the CPU 101 of the processing state by the status register. The encoder 106 reads and encodes the band in the band memory area 104c of the main memory 104, and writes the code in the code page memory area 104d of the main memory 104.

The decoder 107C for C printing decodes the code in the code page memory area 104d of the main memory 104, synchronized with the printer engine 107C for C printing, and transfers the code to the image processing apparatus 108C for C printing. The image processing apparatus 108C for C printing receives the image data from the decoder 107C for C printing, performs the image processing, and transfers the image data to the engine controller 109C for C printing. The engine controller 109C for C printing transfers the image subjected to the image processing received from the image processing apparatus 108C for C printing to the printer engine 110C for C printing.

The decoder 107M for M printing decodes the code in the code page memory area 104d of the main memory 104, synchronized with the printer engine 107M for M printing, and transfers the code to the image processing apparatus 108M for M printing. The image processing apparatus 108M for M printing receives the image data from the decoder 107M for M printing, performs the image processing, and transfers the image data to the engine controller 109M for M printing. The engine controller 109M for M printing transfers the image subjected to the image processing received from the image processing apparatus 108M for M printing to the printer engine 110M for M printing.

The decoder 107Y for Y printing decodes the code in the code page memory area 104d of the main memory 104, synchronized with the printer engine 107Y for Y printing, and transfers the code to the image processing apparatus 108Y for Y printing. The image processing apparatus 108Y for Y printing receives the image data from the decoder 107Y for Y printing, performs the image processing, and transfers the image data to the engine controller 109Y for Y printing. The engine controller 109Y for Y printing transfers the image subjected to the image processing received from the image processing apparatus 108Y for Y printing to the printer engine 110Y for Y printing.

The decoder 107K for K printing decodes the code in the code page memory area 104d of the main memory 104, synchronized with the printer engine 107K for K printing, and transfers the code to the image processing apparatus 108K for K printing. The image processing apparatus 108K for K printing receives the image data from the decoder 107K for K printing, performs the image processing, and transfers the image data to the engine controller 109K for K printing. The engine controller 109K for K printing transfers the image subjected to the image processing received from the image processing apparatus 108K for K printing to the printer engine 110K for K printing.

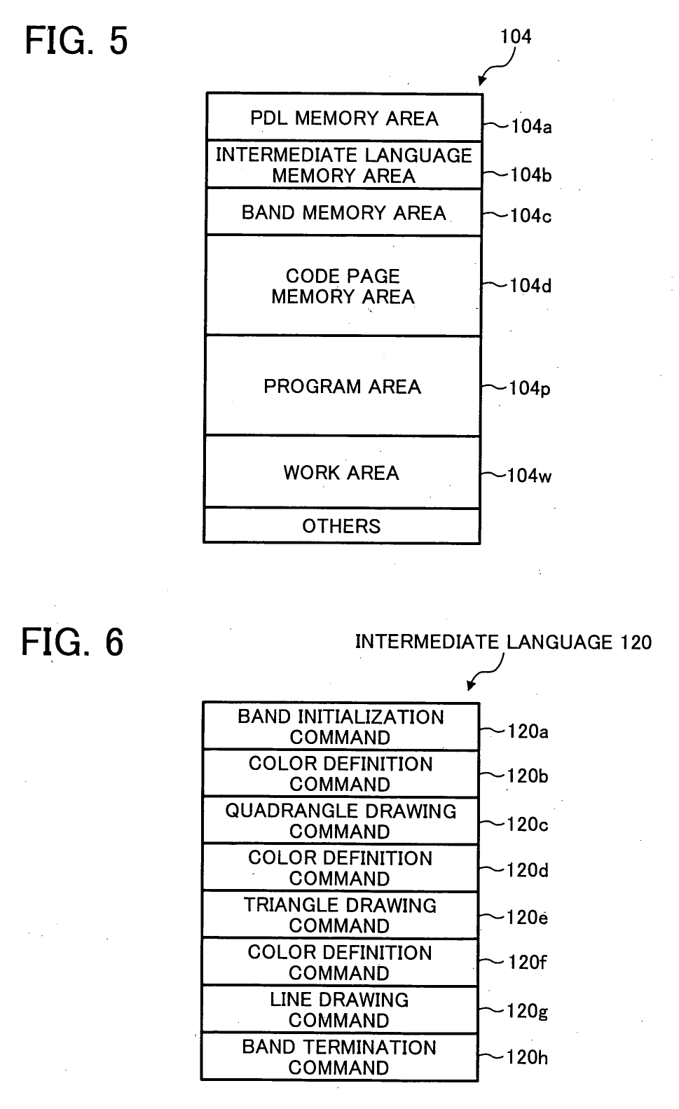

FIG. 5 is a schematic for illustrating a format example of a main memory 104 shown in FIG. 2. The PDL from the PC 200 is stored in the PDL memory area 104a. The intermediate language created by the CPU 101 is stored in the intermediate language memory area 104b. The band data is stored in the band memory area 104c. The encoded code data of the band for one page is stored in the code page memory area 104d for a plurality of pages. The programs for the CPU 101 are stored in a program area 104p. An intermediate result of the processing of the CPU 101 and the like is stored in a work area 104w.

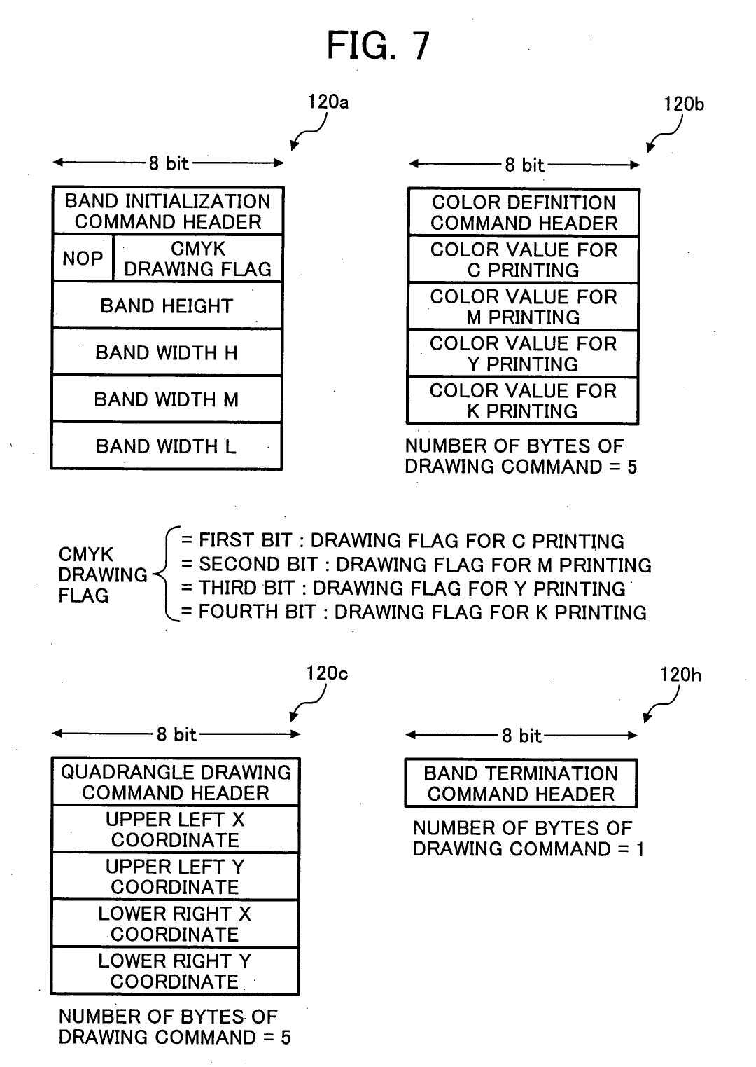

FIG. 6 is a schematic for illustrating an example of the intermediate language 120 stored in the intermediate language memory area 104b shown in FIG. 5. A band initialization command 120a is a command for defining information relating to the start of the band and defines information such as the band height, the band width, a CMYK drawing flag specified by the drawing version as shown in FIG. 7. A color definition command 120b is a command for defining the color of a command for drawing processing hereunder, and defines the color of CMYK as shown in FIG. 7. A quadrangle drawing command 120c is a command for drawing a quadrangle, and draws the X, Y coordinate on upper left and the X, Y coordinate on upper right of a quadrangle to be drawn with color information defined previously by the closest color definition command. A band termination command 120h is a command for defining the termination of the band, and when the processing is performed for each band, it means completion of the drawing processing. An example thereof is shown in FIG. 7.

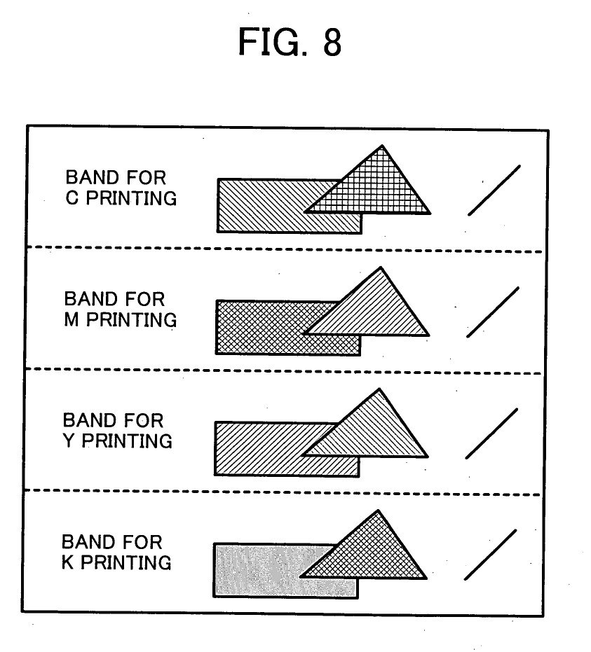

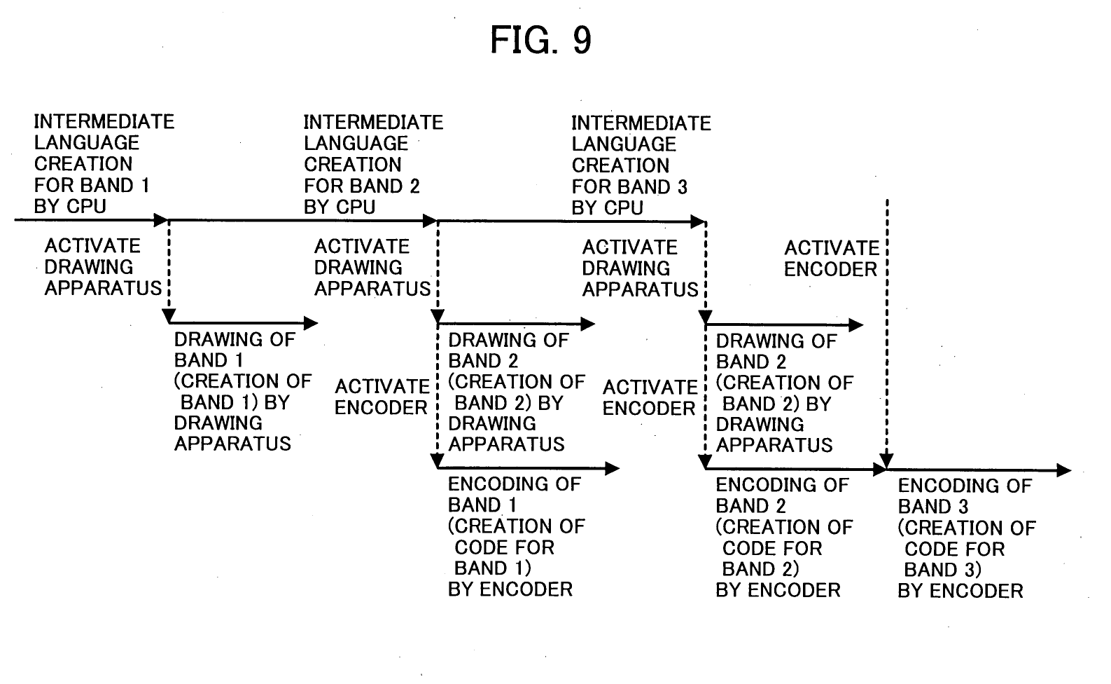

FIG. 8 is a schematic for illustrating a drawing example of the band in the intermediate language 120 shown in FIG. 6. FIG. 9 is a timing chart for generation of the intermediate language by the CPU and parallel processing of the drawing unit 105 and the encoder 106 shown in FIG. 4. At first, the CPU 101 creates an intermediate language for band 1, activates the drawing unit 105, and creates an intermediate language for the next band 2, during drawing of the band 1 by the drawing unit 105. The CPU 101 confirms completion of drawing by the drawing unit 105, activates the drawing unit 105 for drawing of the band 2, activates the encoder 106 for the band 1, and creates an intermediate language for band 3.

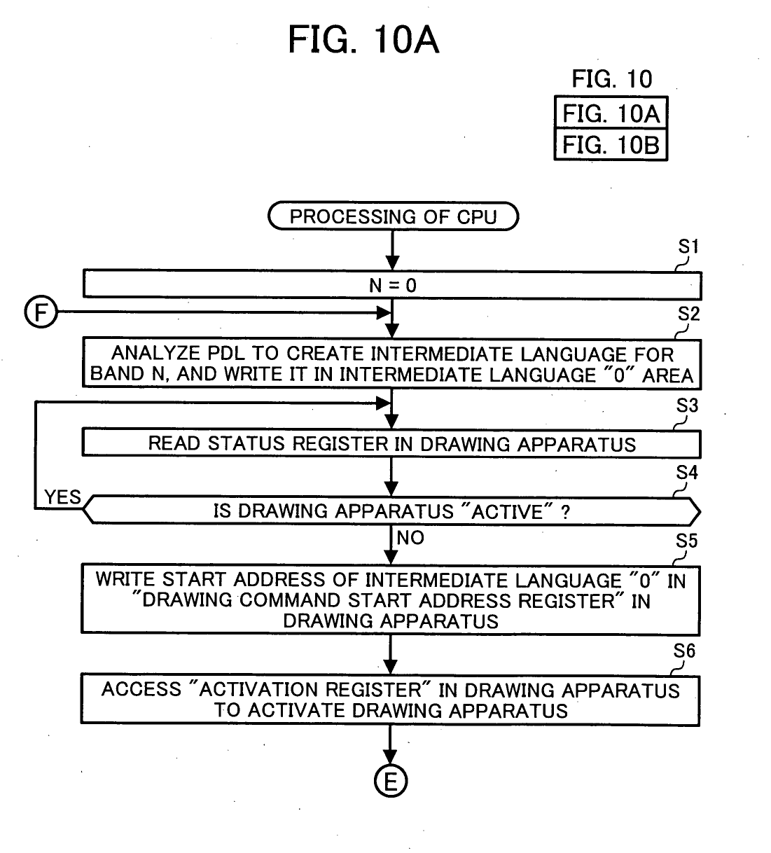

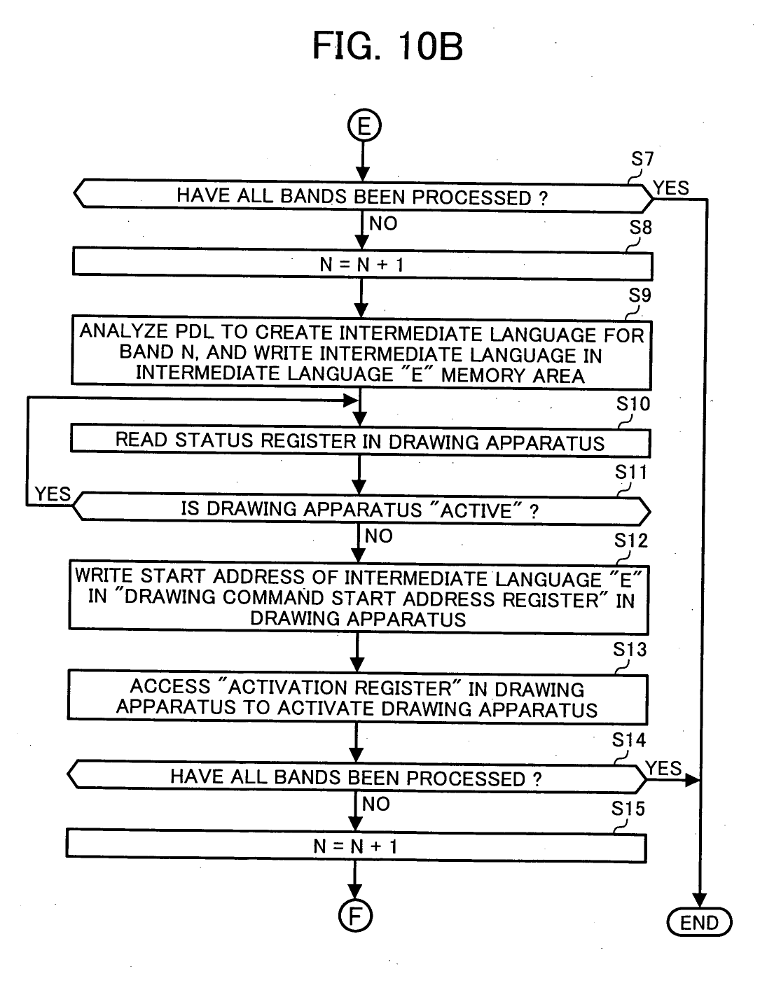

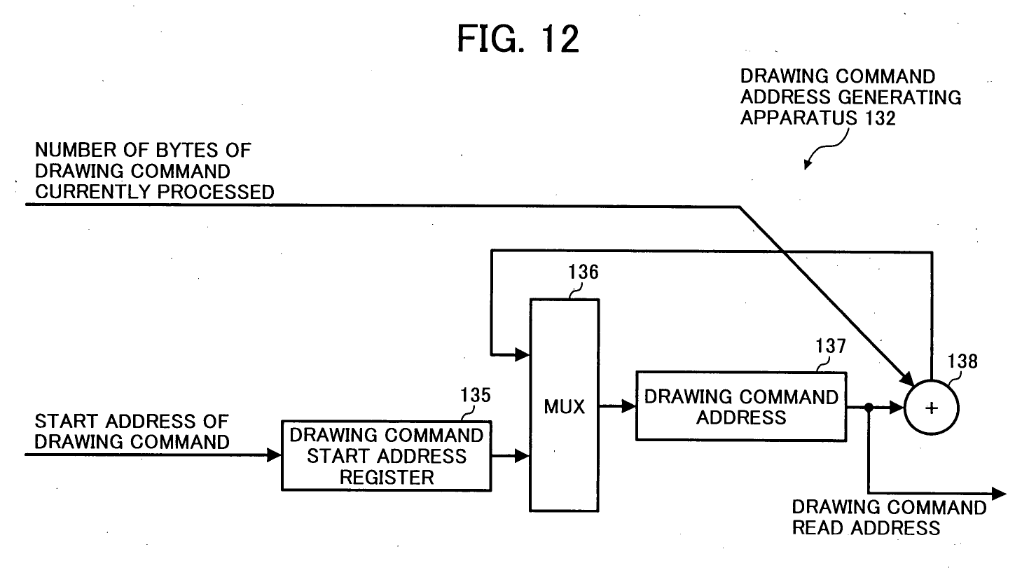

FIG. 10 is a flowchart of the control operation of the CPU 101 according to the first embodiment. The control operation will be explained basically with reference to the block diagram shown in FIG. 4. The CPU 101 initializes band N (step S1), creates an intermediate language for the band N by analyzing the PDL transmitted from the PC 200, writes the intermediate language in the intermediate language “0” memory area 104b (0) (step S2), and reads the status register in the drawing unit 105a (step S3). The CPU 101 determines whether the drawing unit 105a is “active” (step S4), and if it is “active”, writes a start address of the intermediate language “0” in a drawing command start address register (see FIG. 12) in the drawing unit 105a (step S5), and accesses an “activation register” in the drawing unit 105a to activate the drawing unit 105a (step S6). The CPU 101 then determines whether the processing for all bands has finished (step S7), and if all bands have not yet been processed, advances the band N by one (step S8), creates an intermediate language for the band N by analyzing the PDL transmitted from the PC 200, writes the PDL in the intermediate language “E” memory area 104b (E) (step S9), and reads the status register in the drawing unit 105a (step S10). Subsequently, the CPU 101 determines whether the drawing unit 105a is “active” (step S11), and if it is “active”, writes the start address of the intermediate language “E” in the drawing command start address register in the drawing unit 105a (step S12), and accesses the “activation register” in the drawing unit 105a to activate the drawing unit 105a (step S13). Thereafter, the CPU 101 determines whether processing for all bands has finished (step S14), and if all bands have not yet been processed, advances the band N by one (step S15), and returns to step S2 to execute the similar control processing.

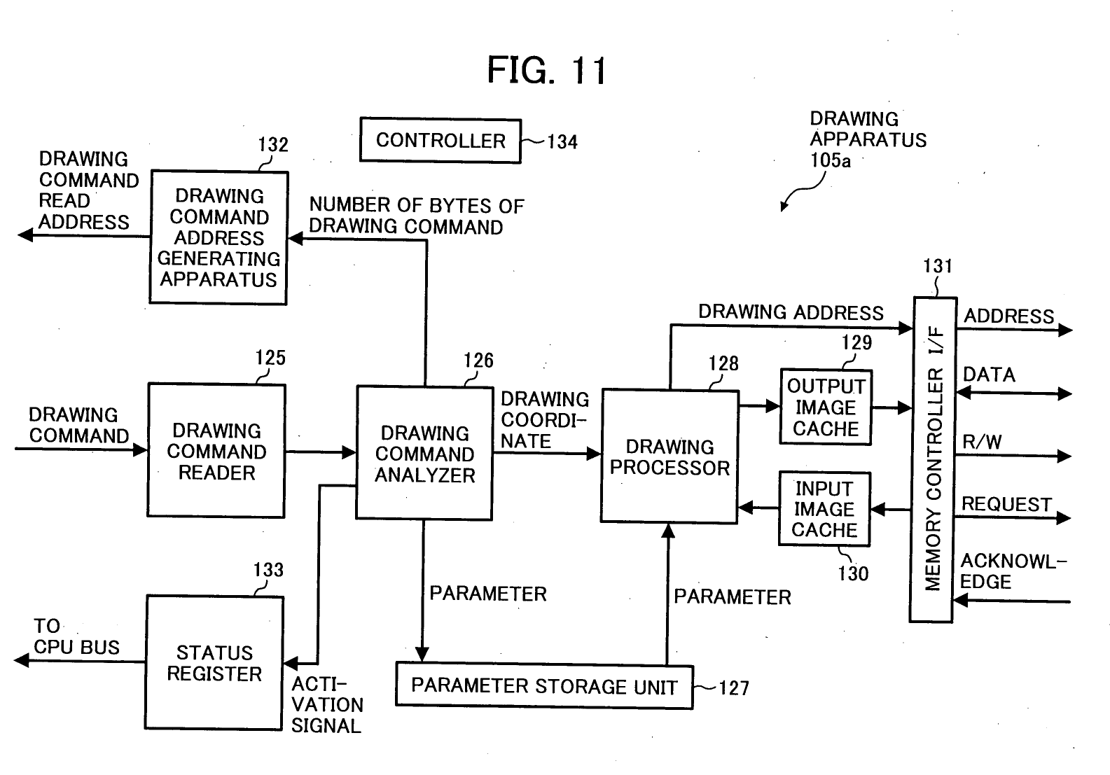

FIG. 11 is a block diagram of the detailed configuration of the drawing unit 105a according to the first embodiment. The drawing unit 105a includes a drawing command reader 125, a drawing command analyzer 126, a parameter storage unit 127, a drawing processor 128, an output image cache 129, an input image cache 130, a memory controller I/F 131, a drawing-command-address generating unit 132, a status register 133, and a controller 134.

The drawing command reader 125 reads the intermediate language from the intermediate language memory area 104B of the main memory 104, and transfers a drawing command to the drawing unit 105a. The drawing command analyzer 126 reads the drawing command from the drawing command reader 125 and analyzes the drawing command to calculate the number of bytes of the drawing command. The drawing command reader 125 transfers the drawing command to the drawing-command-address generating unit 132, transfers coordinates information to be drawn to the drawing processor 128, transfers information such as height and width of the band in the band initialization command shown in FIG. 7 and color information of the color definition command to the parameter storage unit 127, and transfers information concerning whether the drawing processor 128 is active to the status register 133.

The parameter storage unit 127 stores the parameter transferred from the drawing command analyzer 126, and transfers the parameter to the drawing processor 128. The drawing processor 128 receives the coordinates information such as X and Y coordinates of a quadrangle drawing command shown in FIG. 7 from the drawing command analyzer 126, transfers the address of the band area in the main memory 104 to be drawn to the memory controller I/F 131, reads the band image data from the input image cache 130, and transfers the image data to be written in the band area of the main memory 104 shown in FIG. 2 to the output image cache 129. The input image cache 130 temporarily stores the image data read from the memory controller I/F 131 and transfers the image data to the drawing processor 128. The output image cache 129 receives and temporarily stores the image data to be drawn from the drawing processor 128 and transfers the image data to the memory controller I/F 131. The memory controller I/F 131 controls the interface with the memory controller 103 shown in FIG. 2. The drawing-command-address generating unit 132 generates an address for reading the intermediate language of the intermediate language memory area 104a of the main memory 104 shown in FIG. 2 (detailed diagram is shown in FIG. 12). The status register 133 receives and stores activation information from the drawing command analyzer 126 and informs the CPU 101 of the reception of the activation information. The controller 134 controls the whole drawing unit 105a.

FIG. 12 is a block diagram of the detailed configuration of the drawing-command-address generating unit 132 shown in FIG. 11. The drawing-command-address generating unit 132 includes a drawing command start address register 135, a multiplexer (MUX) 136, a drawing command address register 137, and an adder 138.

The drawing command start address register 135 stores the start address of the drawing command set from the CPU 101. The MUX 136 selects to set the drawing command start address set from the CPU 101 in the drawing command address register 137, or to set the address updated by the adder 138. The drawing command address register 137 stores the start address of the drawing command. The adder 138 adds the number of bytes of the drawing command and calculates the top address of the next drawing command.

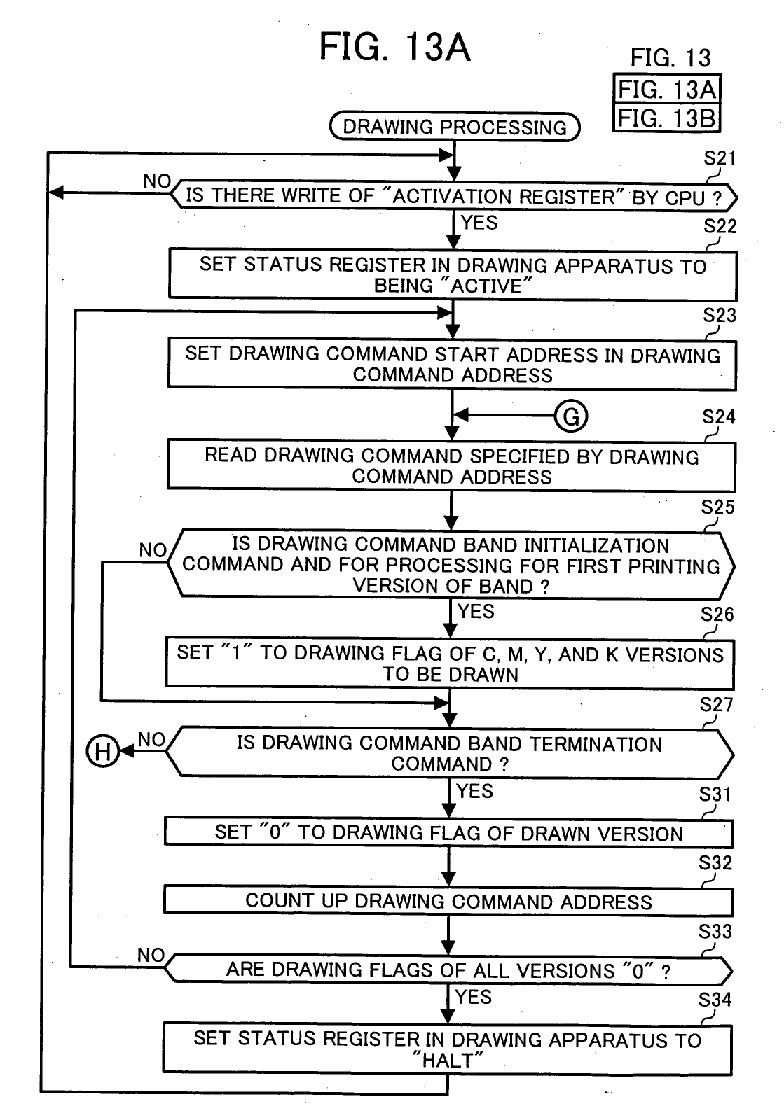

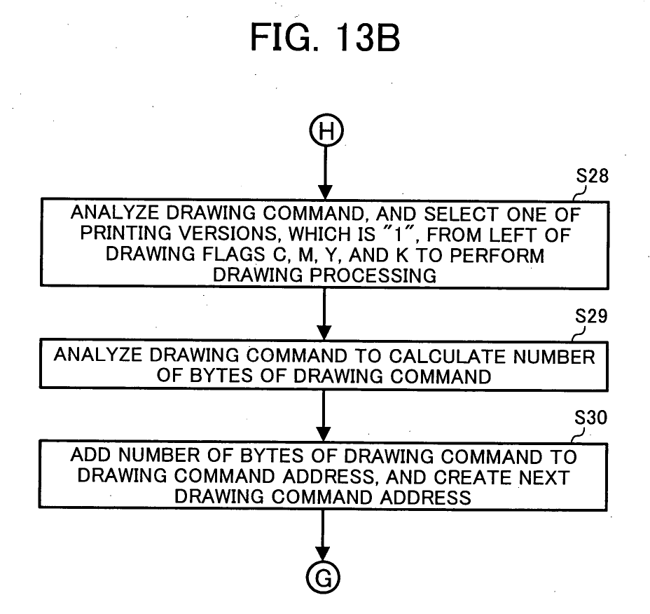

FIG. 13 is a flowchart of the processing operation of the drawing unit 105a according to the first embodiment. The processing operation is executed by the controller 134 (see FIG. 11). The controller 134 determines first whether there is write of the “start register” by the CPU 101 (step S21), and sets the value of the status register 133 in the drawing unit 105a to be “active” (step S22). Subsequently, the controller 134 sets the drawing command start address in the drawing command address (step S23), and reads the drawing command set by the drawing command address (step S24). Furthermore, the controller 134 determines whether the drawing command is the band initialization command and for the processing for first printing of the band (step S25).

At step S25, when the drawing command is the band initialization command and for the processing for first printing of the band, the controller 134 sets “1” to drawing flags of Y, M, C, and K printing versions to be drawn (step S26), and determines whether the drawing command is a band termination command (see FIG. 7) (step S27). If it is the band termination command, the controller 134 analyzes the drawing command and performs the drawing processing by selecting one of the printing versions which is “1” from the left of the drawing flags C, M, Y, and K (step S28). Subsequently, the controller 134 analyzes the drawing command to calculate the number of bytes of the drawing command (step S29), adds the number of bytes of the drawing command to the drawing command address, creates the next drawing command (step S30), and returns to step S24.

On the other hand, if the drawing command is not the band termination command at step S27, the controller 134 sets “0” to the drawing flag of the drawn printing version (step S31), and counts up the drawing command address (step S32). The controller 134 then determines whether the drawing flags of all printing versions are “0” (step S33). If the drawing flags of all printing versions are “0”, the controller 134 sets the value of the status register 133 in the drawing unit 105a to “halt” (step S34), and returns to step S21. On the other hand, if the drawing flags of all printing versions are not “0” at step S33, the controller 134 returns to step S23 to execute the subsequent operation repetitively.

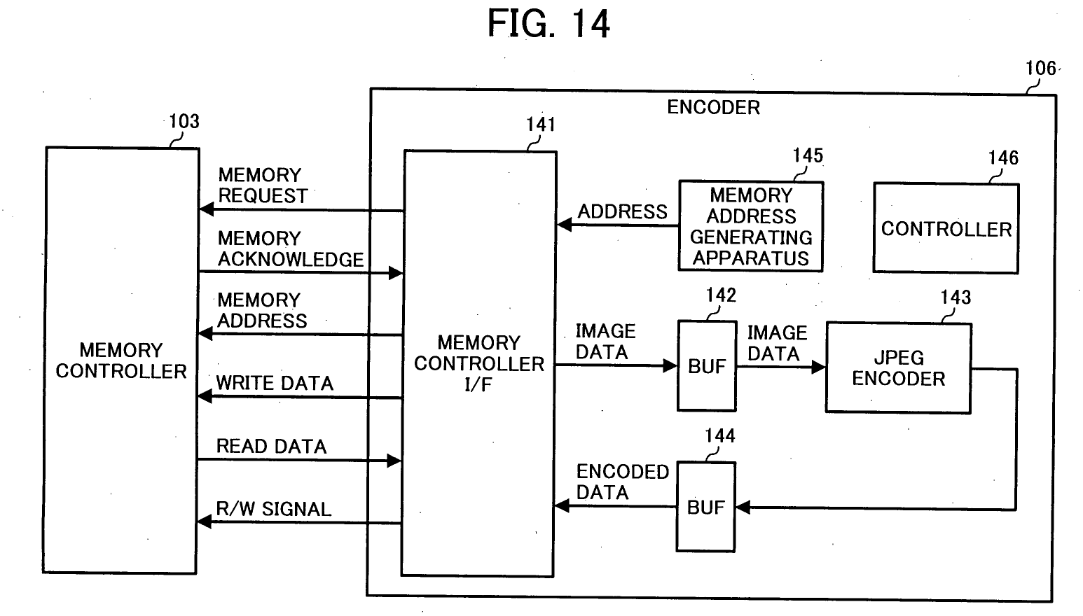

FIG. 14 is a block diagram of the detailed configuration of the encoder 106 shown in FIG. 2. The encoder 106 includes a memory controller I/F 141, a buffer (BUF) 142, a JPEG encoder 143, a buffer (BUF) 144, a memory address generating apparatus 145, and a controller 146.

The memory controller I/F 141 executes the control of interface with the memory controller 103 shown in FIG. 2. The buffer 142 temporarily stores the image data. The JPEG encoder 143 encodes the image data according to an encoding method conforming to the JPEG standard and transfers the encoded image data to the buffer 144. The buffer 144 temporarily stores the encoded data. The memory address generating apparatus 145 generates an address for reading the image data from the band memory area 104c of the main memory 104 shown in FIG. 2, and also generates an address for writing the encoded data in the code page memory area 104d of the main memory 104 shown in FIG. 2. The controller 146 controls the whole encoder 106.

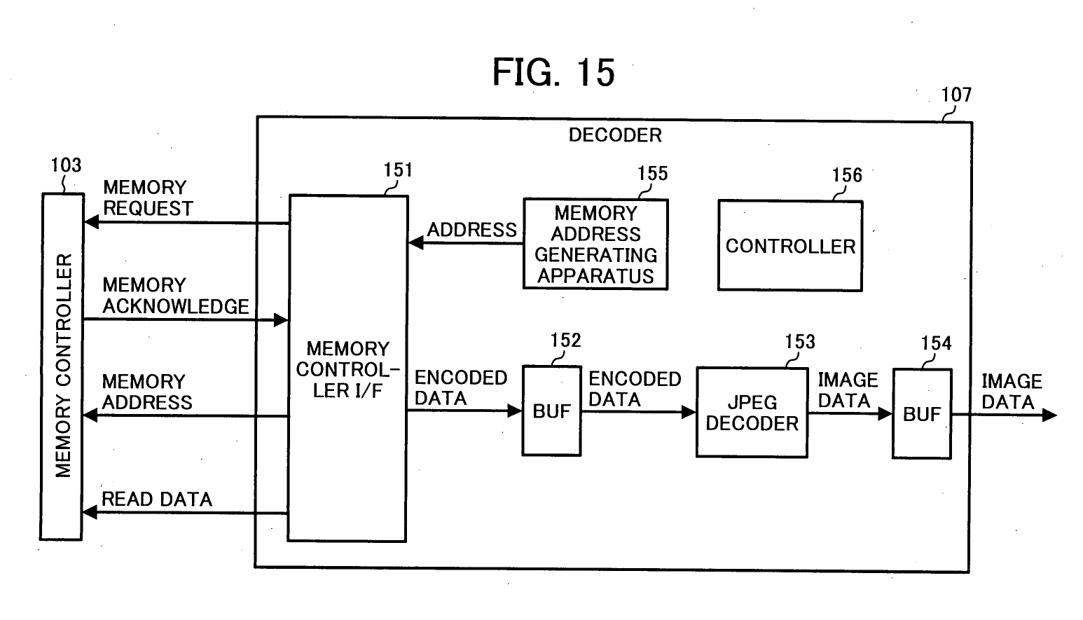

FIG. 15 is a block diagram of the detailed configuration of the decoder 107 shown in FIG. 2. The decoder 107 includes a memory controller I/F 151, a buffer (BUF) 152, a JPEG decoder 153, a buffer (BUF) 154, a memory address generating apparatus 155, and a controller 156.

The memory controller I/F 151 executes the control of interface with the memory controller 103 shown in FIG. 2. The buffer 152 temporarily stores the encoded data. The JPEG decoder 153 decodes the encoded data according to a decoding method conforming to the JPEG Standard and transfers the decoded data to the buffer 154. The buffer 154 temporarily stores the decoded data. The memory address generating apparatus 155 generates an address for reading the encoded data from the code page memory area 104d of the main memory 104 shown in FIG. 2. The controller 156 controls the whole decoder 107.

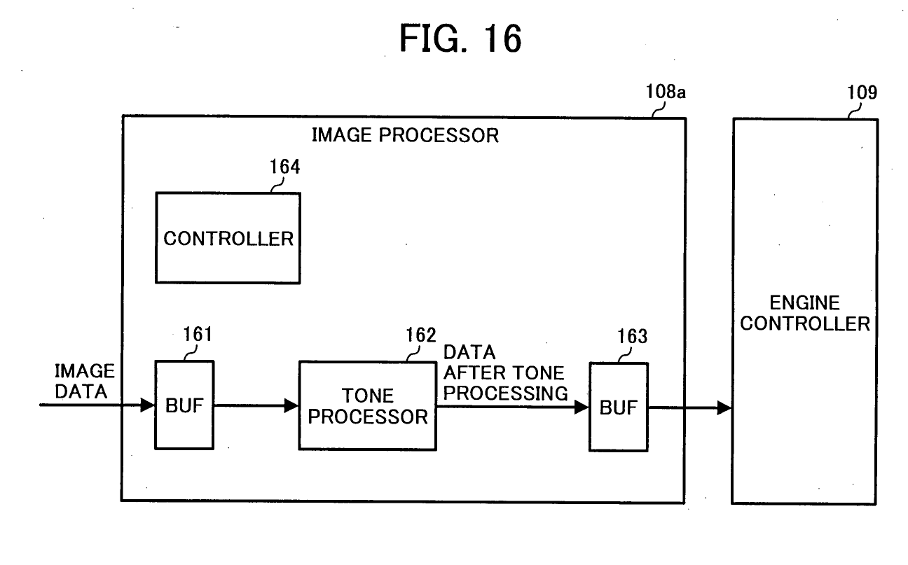

FIG. 16 is a block diagram of the detailed configuration of the image processing apparatus 108a shown in FIG. 2. The image processing apparatus 108a includes a buffer (BUF) 161, a tone processor 162, a buffer (BUF) 163, and a controller 164.

The buffer 161 temporarily stores the image data. The tone processor 162 performs the tone processing with respect to the multi-level image data in the buffer 161 to create image data after tone processing of the respective printing versions. The buffer 163 temporarily stores the image data after the tone processing. The controller 164 controls the whole image processing apparatus 108a.

Therefore, according to the first embodiment, the intermediate language is an intermediate language for one of the CMYK printing versions, and the drawing unit can read and draw the intermediate language for a plurality of times for each printing version. Since the CPU 101 needs only to create one intermediate language, the workload in the intermediate language creation processing by the CPU 101 is reduced, and the memory capacity of the used memory can be reduced.

Furthermore, the PDL analysis processing is performed in the unit of a band, to create an intermediate language for each unit of a band, the intermediate language creation processing and the drawing processing are performed in parallel, and the drawn band data is encoded in parallel by the encoding processing. The created code in the unit of page is decoded in parallel by the decoding processing, thereby realizing a pipeline processing having large parallelism. Accordingly, speed-up can be realized, and since decoding and printing are started after the page code for one page is created, there is no concern about overrun. Furthermore, by executing the pipeline processing, creation and consumption are sequentially performed, and since a plurality of intermediate languages and bands are not created, the memory capacity can be reduced.

It is an embodiment of the present invention to reduce the time during which the drawing data created by the drawing unit is stored in the memory by serially controlling band creation by the drawing unit and compression processing of the band by the encoder, and to improve the system efficiency, by eliminating the memory contention between the drawing processing and the encoding processing.

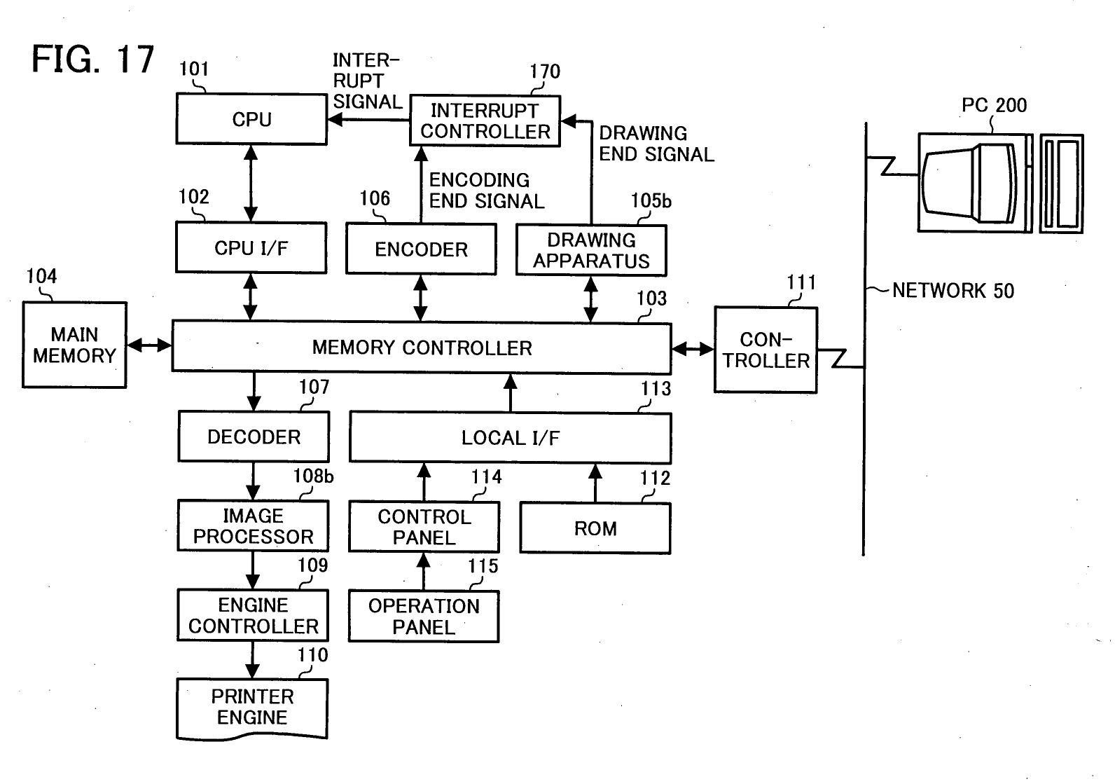

A configuration of a color printer according to a second embodiment of the present invention is the same as that of FIG. 1, and the redundant explanation thereof is omitted. As shown in FIG. 17, basically, the configuration of the transmission controller is such that an interrupt controller 170 is added between the drawing unit 105b, the decoder 107, and the CPU 101 with respect to the configuration shown in FIG. 2. Therefore, as shown in FIG. 2, like reference signs designate like function as shown in FIG. 1, and the redundant explanation is omitted. The basic flow in the image processing is similar to that shown in FIG. 3.

The interrupt controller 170 receives various end signals from the drawing unit 105b and the encoder 106, to generate an interrupt signal with respect to the CPU 101.

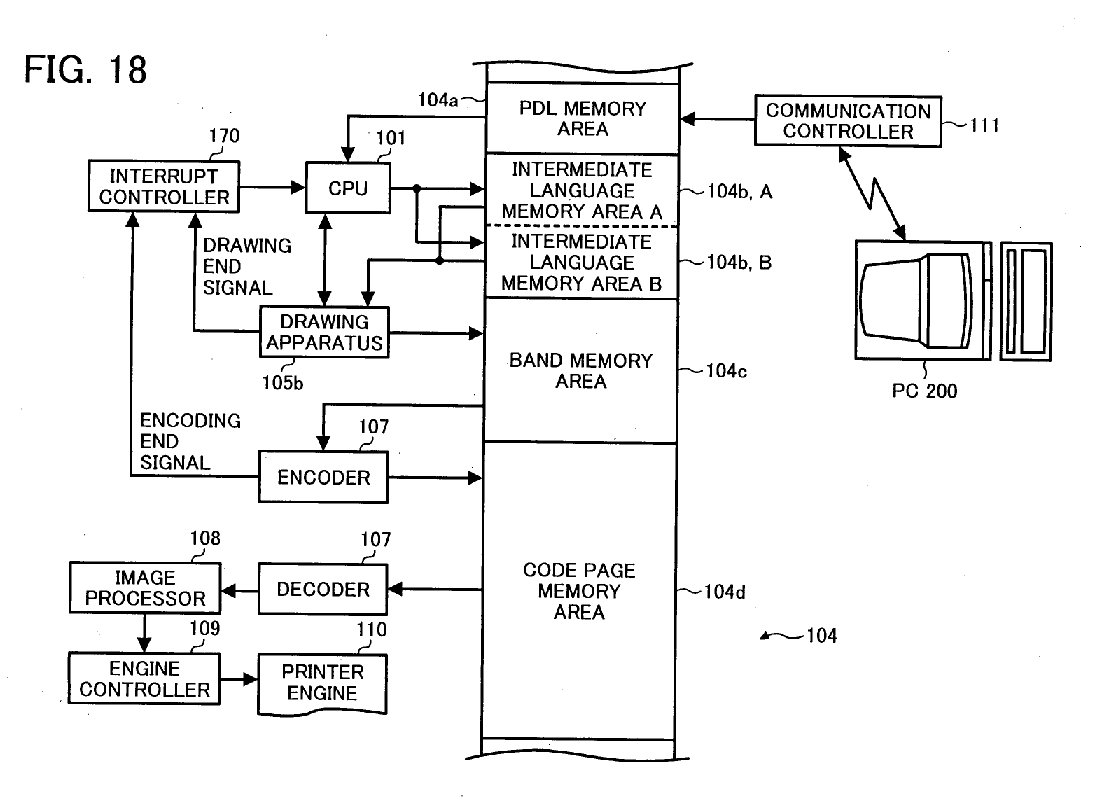

FIG. 18 is a block diagram of the concept of the image processing according to the second embodiment. The PC 200 creates the PDL and transfers it to the printer via the network 50. The communication controller 111 in the printer receives the PDL from the PC 200 and stores the PDL in the PDL memory area 104a of the main memory 104. The main memory 104 stores the PDL, the intermediate language, the band data, the page codes, programs, various kinds of work data, and the like.

The main memory 104 has two areas, intermediate language memory areas 104b(A) and 104b(B). While the drawing unit 105b is performing the drawing processing in the band memory by reading the intermediate language in, for example, the intermediate language memory area 104b(A), the CPU 101 can create the intermediate language for the next band in the intermediate language memory area 104b(B).

The CPU 101 analyzes the PDL from the PC 200 and creates the intermediate language. The drawing unit 105b reads the intermediate language in the main memory 104 and draws the band in the band memory area 104c of the main memory 104. When having finished the drawing processing, the drawing unit 105b transmits an end signal to the interrupt controller. The encoder 106 reads and encodes the band in the band memory area 104c of the main memory 104, and writes the band in the code page memory area 104d of the main memory 104. When having finished the encoding, the encoder 106 transmits an end signal to the interrupt controller 170. The interrupt controller 170 receives the end signal from the drawing unit 105 and the encoder 106 to generate an interrupt signal and transfers it to the CPU 101. The decoder 107 decodes the code in the code page memory area 104d of the main memory 104, synchronized with the printer engine 110, and transfers the decoded code to the image processing apparatus 108b. The image processing apparatus 108b receives the image data from the decoder 107 to perform the image processing, and transfers the image data to the engine controller 109. The engine controller 109 transfers the image-processed image data received from the image processing apparatus 108b to the printer engine 110.

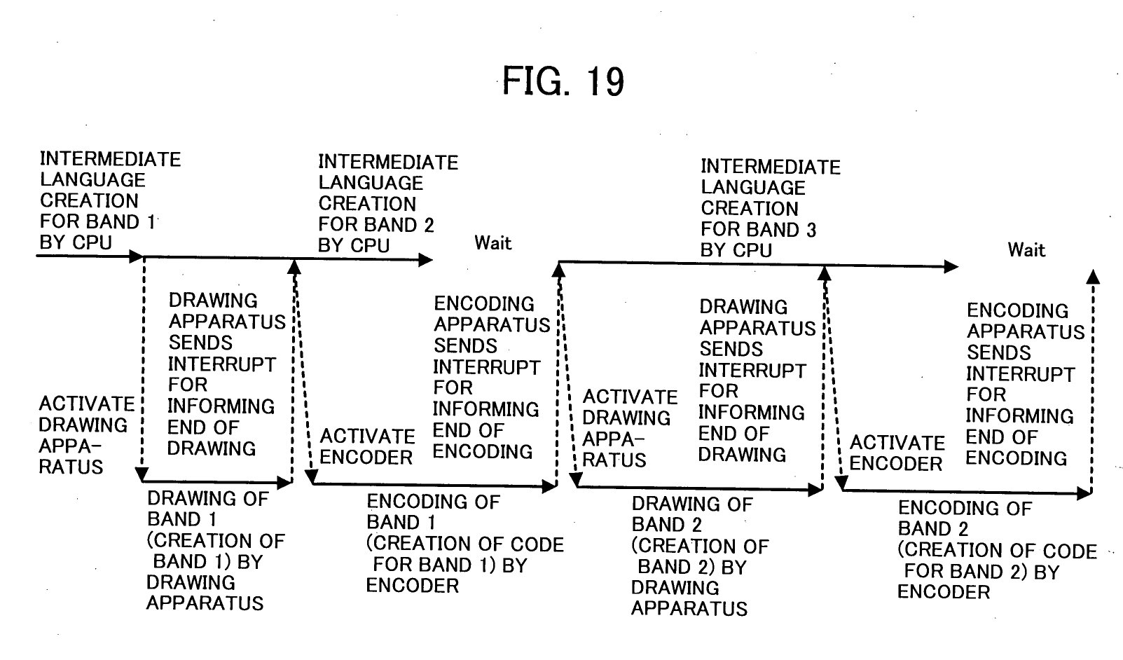

FIG. 19 is a timing chart for the operation of the intermediate language creation and drawing processing according to the second embodiment. The drawing unit 105 (see FIG. 18) interrupts the CPU 101 and informs the CPU 101 of the completion of the drawing processing, and the CPU 101 suspends creation of the intermediate language for the next band to activate the encoder, and thereafter, restarts creation of the intermediate language. Thus, by controlling the sequence of the drawing and encoding processing, memory contention is reduced, and the system efficiency can be improved.

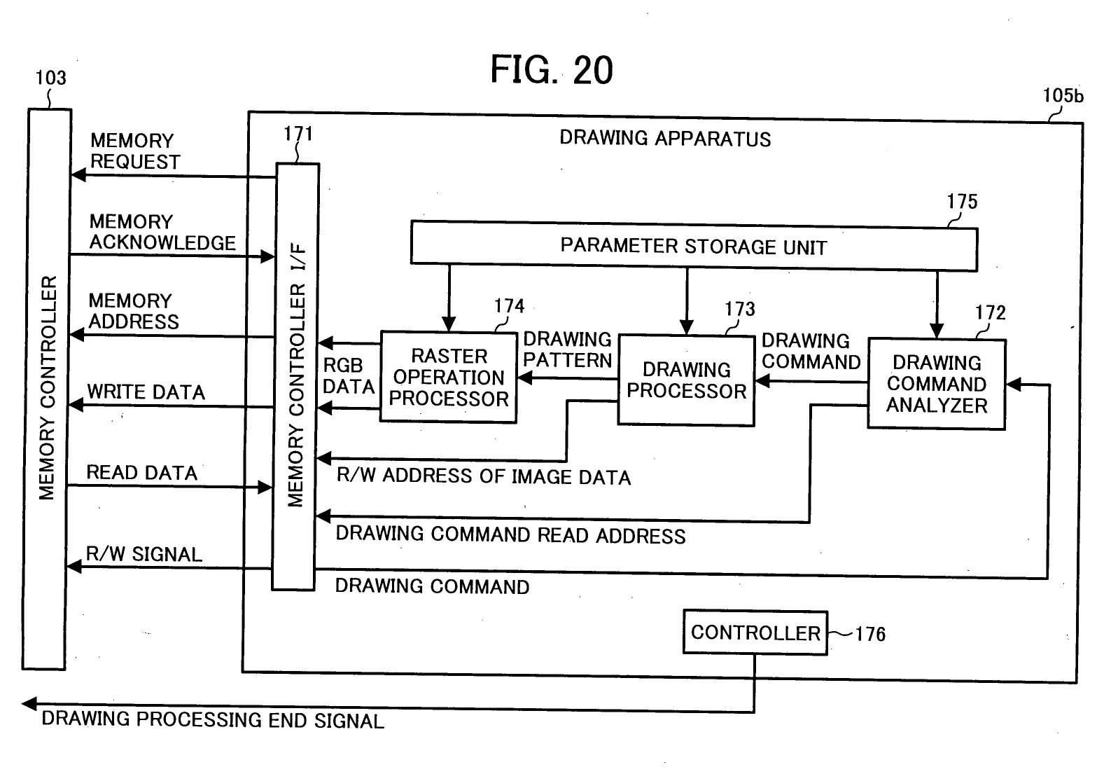

FIG. 20 is a block diagram of the detailed configuration of the drawing unit 105b according to the second embodiment. The drawing unit 105b includes a memory controller I/F 171, a drawing command analyzer 172, a drawing processor 173, a Raster operation processor (ROP) 174, a parameter storage unit 175, and a controller 176.

The memory controller I/F 171 executes the control of interface with the memory controller 103 shown in FIG. 17. The drawing command analyzer 172 reads the intermediate language from the intermediate language memory area 104b of the main memory to analyze the drawing command, and transfers the drawing command to the drawing unit 105b. The drawing unit 105b reads the drawing command from the drawing command analyzer 172 and transfers the drawing data to the ROP 174. The ROP 174 performs logic operation and drawing in the band memory area 104c of the main memory 104. Necessary parameters for the drawing unit 105b are set in the parameter storage unit 175 by the CPU 101 and stored therein. The controller 176 controls the whole drawing unit 105b.

The encoder and the decoder according to the second embodiment are the same as those shown in FIGS. 14 and 15 according to the first embodiment. Therefore, the redundant explanation thereof is omitted.

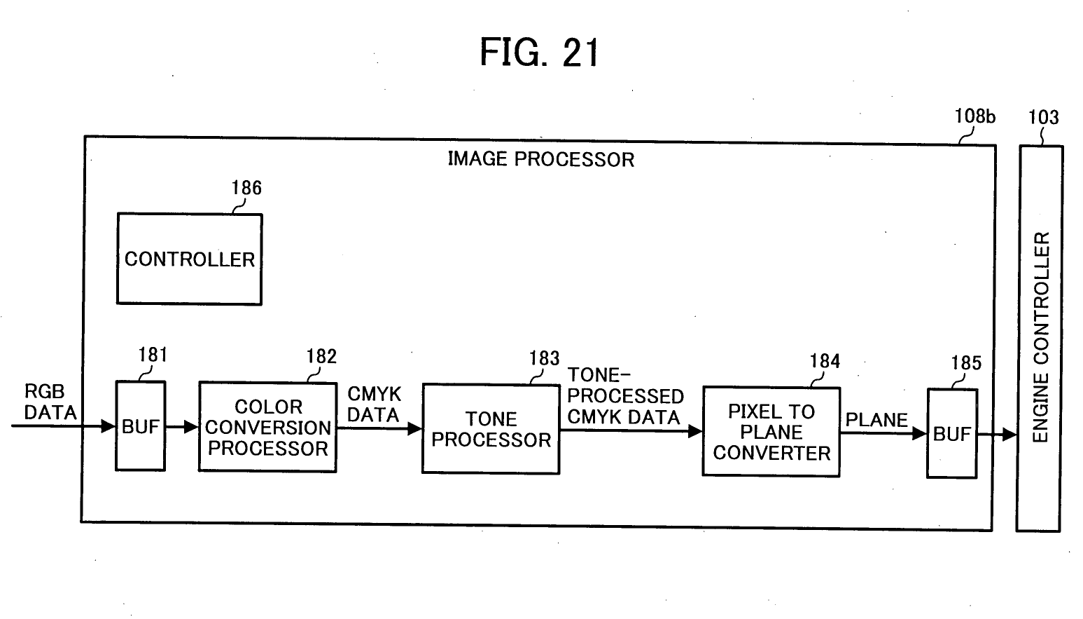

FIG. 21 is a block diagram of the detailed configuration of the image processing apparatus 108b according to the second embodiment. The image processing apparatus 108b includes a buffer (BUF) 181, a color conversion processor 182, a tone processor 183, a PIXEL to PLANE converter 184, and a buffer (BUF) 185.

The buffer 185 temporarily stores the image data. The color conversion processor 182 converts colors from RGB image data to CMYK image data. The tone processor 183 performs the tone processing with respect to the multi-level CMYK data from the color conversion processor 182 and creates the tone-processed CMYK data. The PIXEL to PLANE converter 184 converts PIXEL data of the CMYK data to plane data of the CMYK. The buffer 185 temporarily stores the image data after the tone processing and transfers the image data to the engine controller 109. The controller 186 controls the whole image processing apparatus 108b.

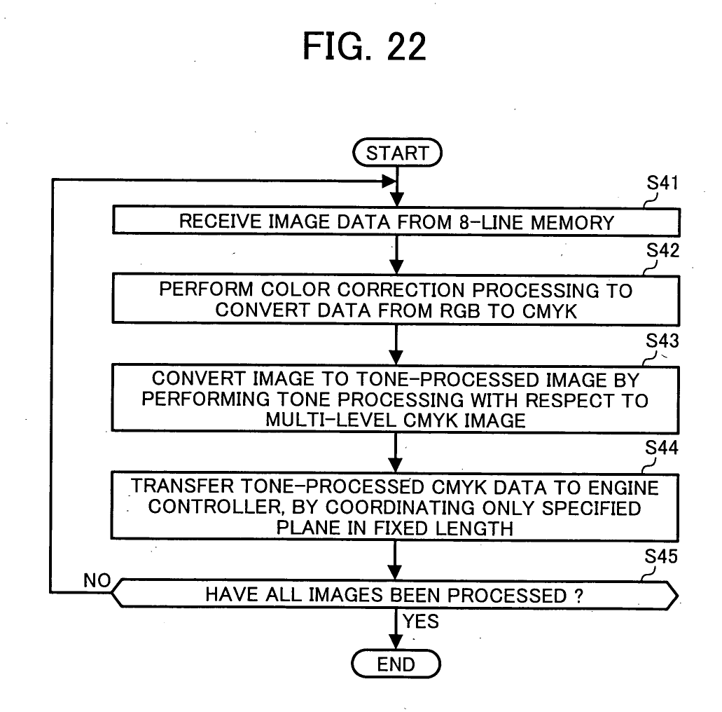

FIG. 22 is a flowchart of the processing operation of the image processing apparatus 108b shown in FIG. 21. The processing operation is executed by the controller 186. The controller 186 first receives the image data from an 8-line memory (buffer 181) (step S41), and the color conversion processor 182 performs color correction processing and converts the data from the RGB data to the CMYK data (step S42). The tone processor 183 performs the tone processing with respect to the CMYK image to convert the CMYK image to the tone-processed image (step S43). The tone-processed CMYK data is transferred to the engine controller 109 by coordinating only the specified plane in a fixed length (step S44). The controller 186 then determines whether all images are processed (step S45), and repetitively executes the above processing, until the processing with respect to all images finishes.

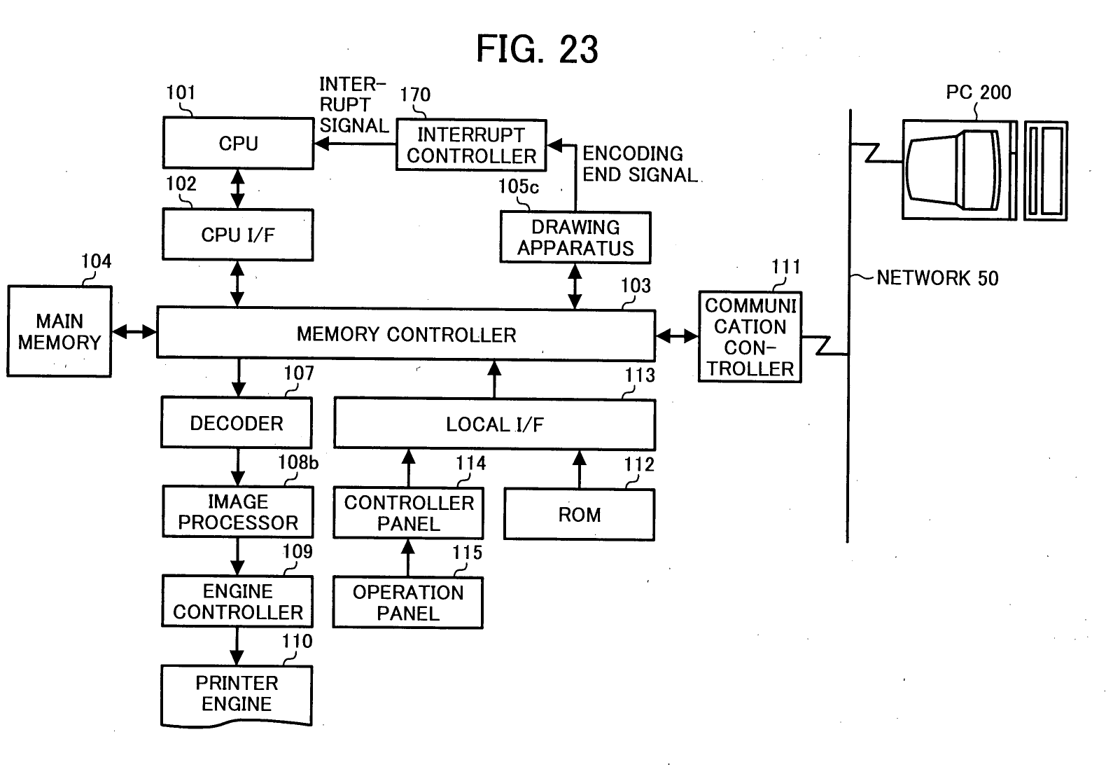

FIG. 23 is a block diagram of the configuration of another transmission controller 26 according to the second embodiment. The transmission controller 26 here has a configuration such that the interrupt controller 170 is arranged between the drawing unit 105c and the CPU 101 with respect to the configuration shown in FIG. 17, and the interrupt controller 170 receives the end signal from the drawing unit 105c to generate an interrupt signal to the CPU 101, so that the encoder 106 is omitted. The other parts of the configuration are the same as shown in FIG. 17, and hence, the redundant explanation thereof is omitted.

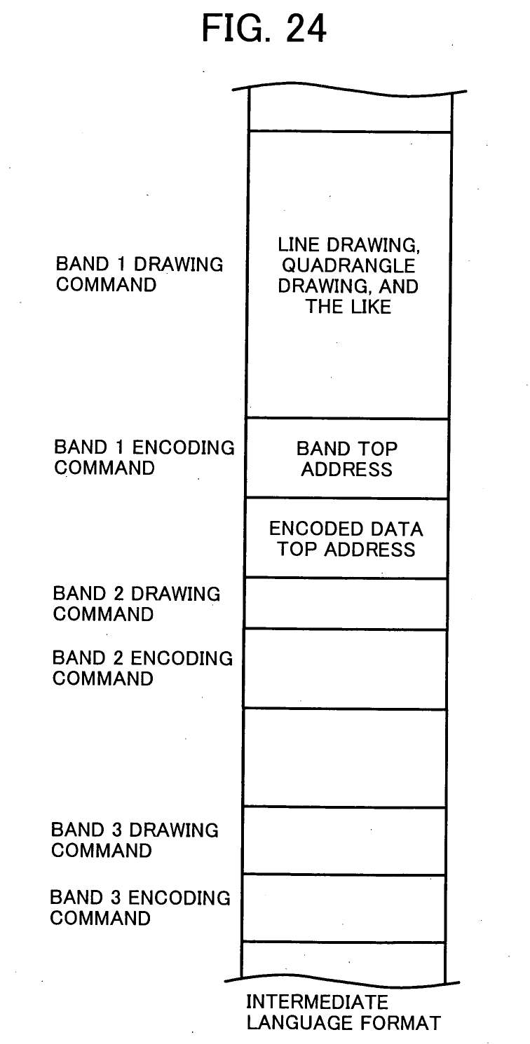

FIG. 24 is a schematic for illustrating a format example of the intermediate language processed by the drawing unit 105c shown in FIG. 23. Thus, a drawing command is followed by an encoding command for encoding the drawing command, and the drawing unit 105c that analyzes and executes the intermediate language can execute the drawing processing and the encoding processing based on the instruction by the intermediate language.

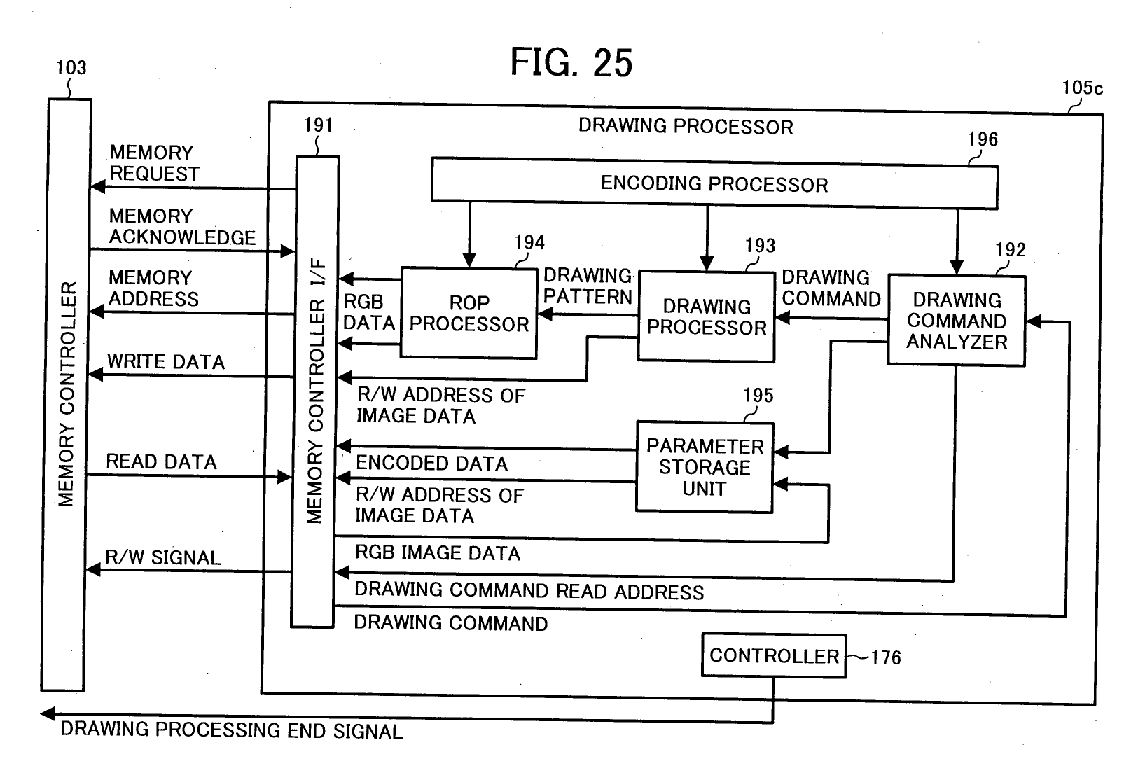

FIG. 25 is a block diagram of the detailed configuration of the drawing unit 105c shown in FIG. 23. The drawing unit 105c includes a memory controller I/F 191, a drawing command analyzer 192, a drawing processor 193, an ROP processor 194, an encoding processing unit 195, a parameter storage unit 196, and the controller 197.

The memory controller I/F 191 executes the control of interface with the memory controller 103 shown in FIG. 23. The drawing command analyzer 192 reads the intermediate language from the intermediate language memory area 104b of the main memory 104 shown in FIG. 23 to analyze the drawing command, and transfers the intermediate language to the drawing processor 193 and the encoding processing unit 195. The drawing processor 193 reads the drawing command from the drawing command analyzer 192 and transfers the drawing data to the ROP processor 194. The ROP processor 194 performs the logic operation and draws in the band memory area 104c of the main memory 104. The encoding processing unit 195 reads the drawing command from the drawing command analyzer 192, and reads and encodes the image data from the band memory area 104c of the main memory 104, to transfer the image data to the code page memory area. The parameter storage unit 196 stores parameters necessary for the drawing unit 105c, which is set by the CPU 101. The controller 197 controls the whole drawing unit 105c.

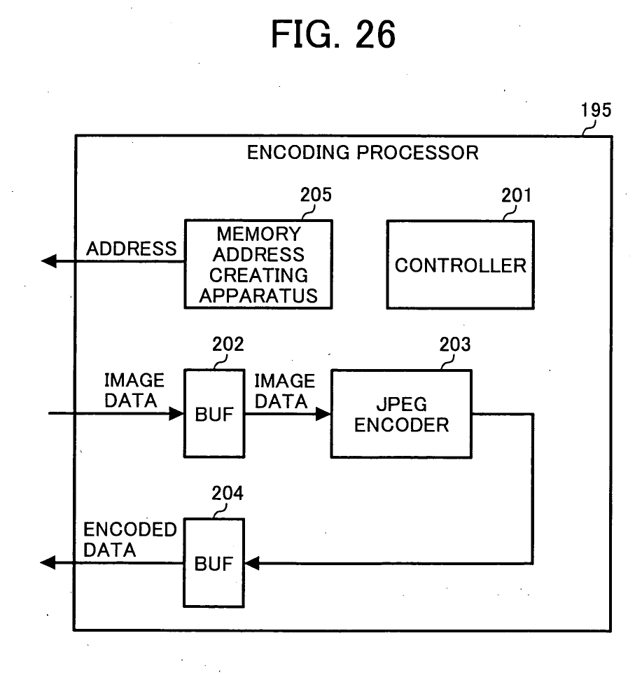

FIG. 26 is a block diagram of the detailed configuration of the encoding processing unit 195 shown in FIG. 25. The encoding processing unit 195 includes a controller 201, a buffer (BUF) 202, a JPEG encoder 203, a buffer (BUF) 204, and a memory address creating apparatus 205.

The buffer 202 temporarily stores the image data. The JPEG encoder 203 encodes the image data according to the encoding method conforming to the JPEG Standard and transfers the encoded image data to the buffer 204. The buffer 204 temporarily stores the encoded data. The memory address creating apparatus 205 creates an address for reading the image data from the band memory area 104b of the main memory 104, and also creates an address for writing the encoded data in the code page memory area 104d of the main memory 104. The controller 201 controls the whole encoding processing unit 195.

The intermediate language is one intermediate language of the CMYK printing versions, and the drawing unit can read and draw the intermediate language for a plurality of times for each printing version. Since the CPU 101 needs only to create one intermediate language, the workload in the intermediate language creation processing by the CPU 101 is reduced, and the memory capacity of the used memory can be reduced.

According to the second embodiment, as shown in FIG. 17, the drawing unit 105b and the encoder 106 respectively create the end signal and transfer the end signal to the interrupt controller 170. The interrupt controller 170 sends the interrupt signal to the CPU 101, and the CPU 101 performs the control shown in FIG. 19. Accordingly, the drawing unit 105c interrupts the CPU 101 and informs the CPU 101 of the completion of the drawing processing, and the CPU 101 suspends creation of the intermediate language for the next band, to activate the encoder, and restarts creation of the intermediate language. Thus, by controlling the sequence of the drawing and encoding processing, memory contention is reduced, and the system efficiency can be improved.

In another example (see FIG. 23) according to the second embodiment, the drawing unit 105c creates the end signal and transfers the end signal to the interrupt controller 170. The interrupt controller 170 transmits an interrupt signal to the CPU 101. The drawing unit 105c executes the processing by the intermediate language format shown in FIG. 24. The drawing command and the encoding command are included in the intermediate language. Accordingly, the drawing unit 105c does not need to perform the interrupt processing informing the CPU 101 of the completion of drawing shown in FIG. 19, thereby removing the idle time due to the interrupt, and improving the system efficiency. Furthermore, the time during which the band data is present in the main memory can be reduced as short as possible, thereby improving the efficiency of the memory.

The image processing method (operation) explained above can be put into a program, recorded in a computer readable recording medium, and executed on a computer. Furthermore, a part of the image processing method can be on a network, and realized through the communication line.

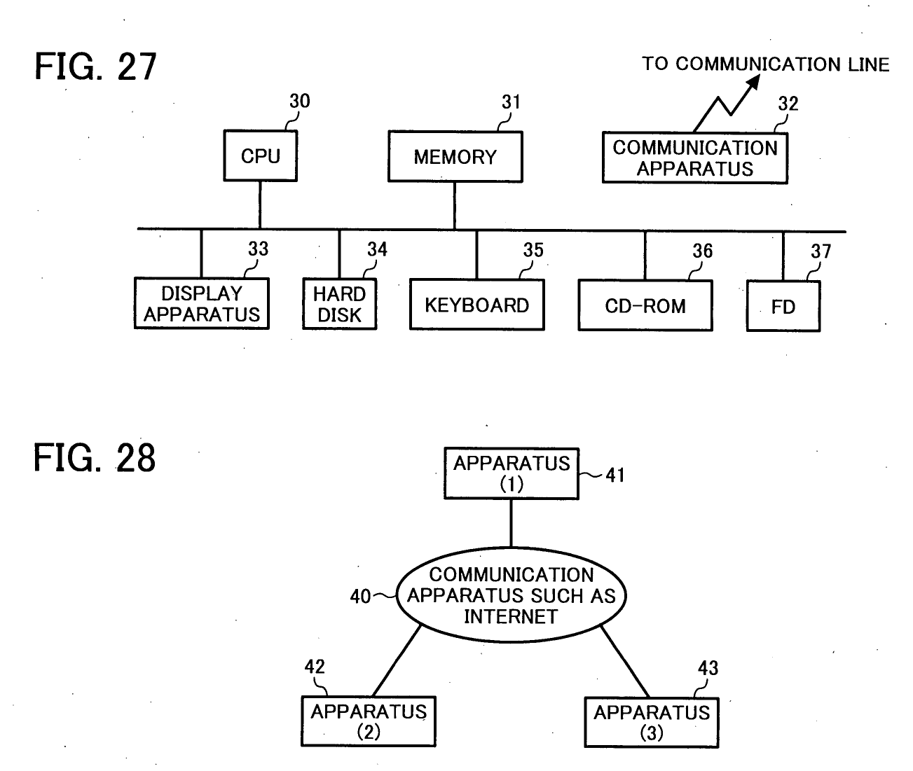

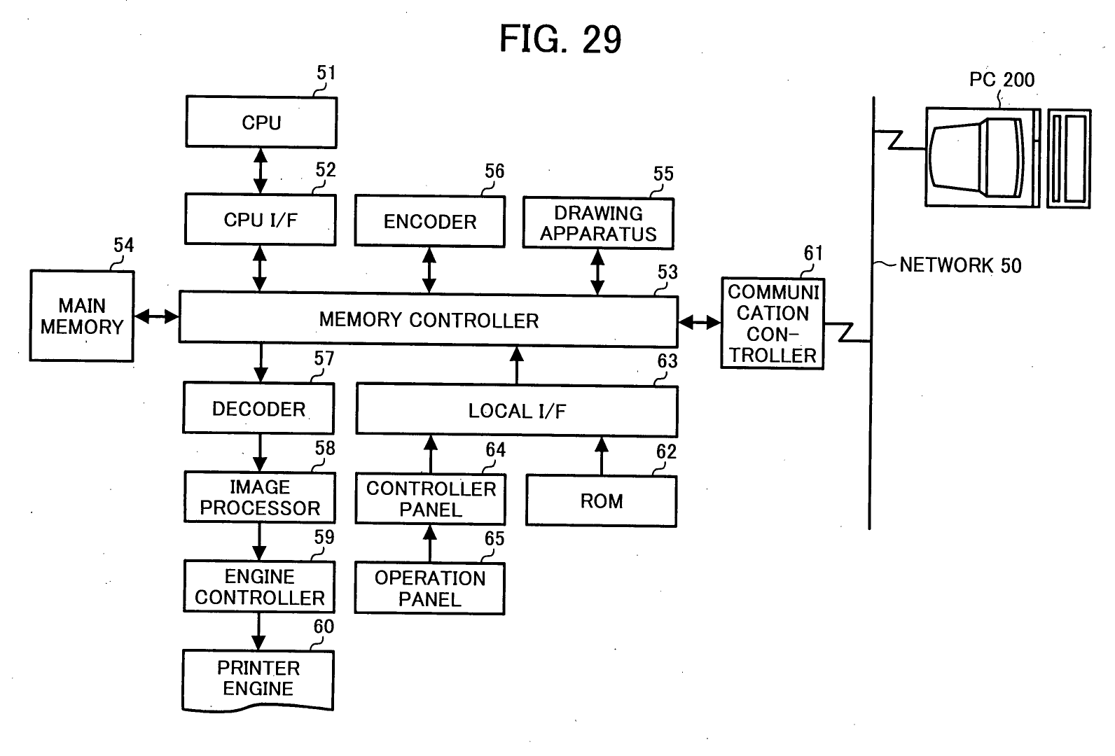

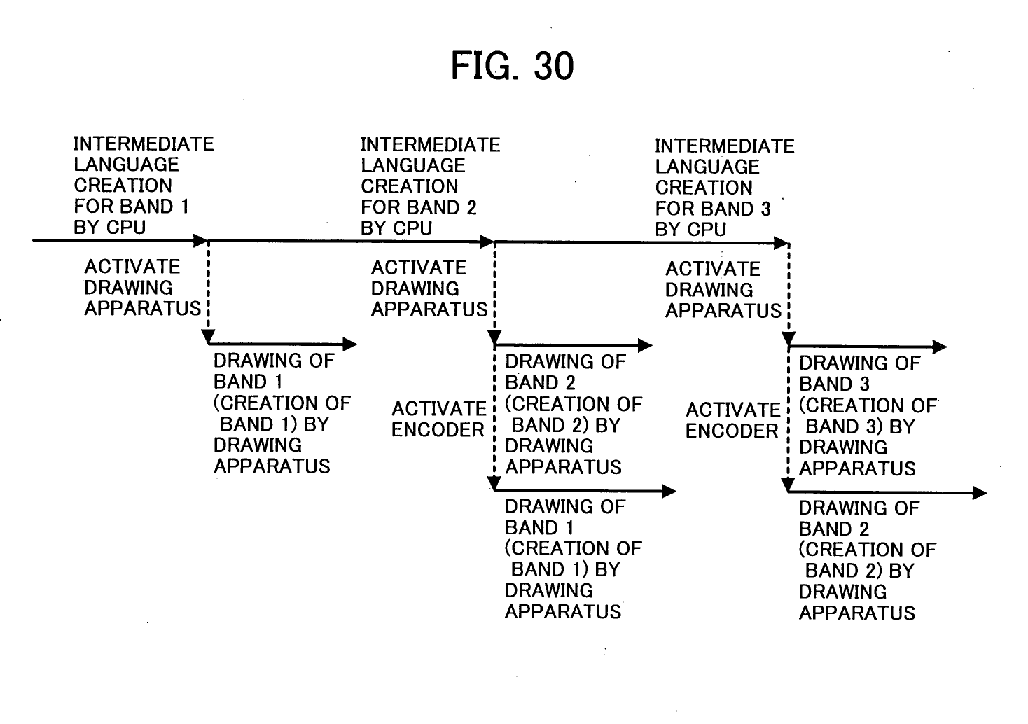

In other words, the image forming method explained in the present embodiments can be realized by executing a prepared program by a computer (CPU 30) such as a personal computer or a workstation as shown in FIG. 27. This program is recorded on a computer readable recording medium, such as a memory 31, a hard disk 34, a flexible disk 37, a compact-disc read only memory (CD-ROM) 36, a magneto optical (MO), or a digital versatile disc (DVD), by operations of a keyboard 35, and is executed by reading the program from the recording medium by the computer (CPU 30), and displaying the program on a display apparatus 33 according to need. Furthermore, the data of the image processing method can be transferred from the communication apparatus 32 to an external apparatus.

As shown in FIG. 28, the program can be distributed to the apparatus 41 to 43 such as a personal computer, through a network such as the Internet, via the recording medium.

That is, for example, the program can be provided in a state that it is installed in a hard disk as a recording medium built in the computer. The program can be provided as package software, by temporarily or permanently storing the program on a recording medium, and incorporating the program in a computer as a unit, or using the program in a format of a detachable recording medium.

For the recording medium, for example, flexible disks, CD-ROM, MO disks, DVD, magnetic disks, and semiconductor memories can be used.

The program can be transferred to a computer from a download site via a network such as a local area network (LAN) or the Internet, by cable or radio transmission, and downloaded to a storage unit such as a built-in hard disk in the computer.

The image processing apparatus according to the present invention performs the analysis processing of the PDL, for example, in the unit of band, to create the intermediate language in the unit of band, encodes in parallel the band data drawn by performing the intermediate language creation processing and the drawing processing in parallel by the encoding processing, and decodes the created code in the unit of page in parallel by the decoding processing. Accordingly, pipeline processing having large parallelism can be realized. Furthermore, since the intermediate language is one intermediate language of the CMYK printing versions, in the drawing processing, the intermediate language can be read and drawn for a plurality of times for each printing version. Since the intermediate language creation unit needs only to generate one intermediate language, the workload in the intermediate language creation processing is reduced, and the memory capacity of the used memory can be reduced. Accordingly, speed-up can be realized. Since decoding and printing are started after the page code for one page is created, there is no concern about overrun. Furthermore, by executing the pipeline processing, creation and consumption are sequentially performed, and since a plurality of intermediate languages and bands are not created, the memory capacity can be reduced.

According to the image processing apparatus of one embodiment of the present invention, a top address with the drawing information relating to the image data for one printing version can be created by the image data creation unit.

Furthermore, according to the image processing apparatus of one embodiment of the present invention, the intermediate-language-top-address storing unit stores the top address in the intermediate-language storing unit, one intermediate language can be created and read out for a plurality of times.

Since the image processing apparatus according to one embodiment of the present invention analyzes the drawing command in the intermediate language read from the intermediate-language storing unit to obtain the size of the respective drawing commands, the memory capacity of the used memory can be reduced.

The image processing apparatus according to one embodiment of the present invention performs the analysis processing of the PDL, for example, in the unit of band or in the unit of page, to create the intermediate language in the unit of band or in the unit of page, encodes in parallel the data drawn by performing the intermediate language creation processing and the drawing processing in parallel by the encoding processing, and decodes the created code in the unit of page in parallel by the decoding processing. Accordingly, pipeline processing having large parallelism can be realized. Furthermore, since the intermediate language is one intermediate language of the CMYK printing versions, in the drawing processing, the intermediate language can be read and drawn for a plurality of times for each printing version. Since the intermediate language creation unit needs only to create one intermediate language, the workload in the intermediate language creation processing is reduced, and the memory capacity of the used memory can be reduced. Accordingly, speed-up can be realized, and an image processing apparatus having no concern about overrun can be provided by staring decoding and printing after the page code for one page is created.

According to the image processing method of one embodiment of the present invention, the analysis processing of the PDL is performed, for example, in the unit of band, to create the intermediate language in the unit of band, the band data drawn by performing the intermediate language creation processing and the drawing processing in parallel is encoded in parallel by the encoding processing, and the created code in the unit of page is decoded in parallel by the decoding processing. Accordingly, pipeline processing having large parallelism can be realized. Furthermore, since the intermediate language is one intermediate language of the CMYK printing versions, in the drawing processing, the intermediate language can be read and drawn for a plurality of times for each printing version. Since the intermediate language creation unit needs only to create one intermediate language, the workload in the intermediate language creation processing is reduced, and the memory capacity of the used memory can be reduced. Accordingly, speed-up can be realized, and an image processing method having no concern about overrun can be provided by staring decoding and printing after the page code for one page is created.

According to the image processing apparatus of one embodiment of the present invention, since the processing controller analyzes the intermediate language, recognizes the completion of the processing of the image data creation unit that creates the image data, and activates the encoding unit that encodes the image data, the band creation and compression processing of the band can be serially controlled, thereby avoiding memory contention between the drawing processing and the encoding processing. Accordingly, the system efficiency can be improved.

The image processing apparatus according to one embodiment of the present invention informs the intermediate language creation unit of the completion of processing of the image data creation unit, to suspend the processing. Accordingly, memory contention between the drawing processing and the encoding processing can be avoided.

The image processing apparatus according to one embodiment of the present invention stores at least the intermediate language being processed by the image data creation unit. Accordingly, it is not necessary to store the intermediate language to be processed in the memory each time, thereby improving the processing efficiency.

Moreover, according to the image processing apparatus of one embodiment of the present invention, the image processing apparatus analyzes the intermediate language, to create the image data, encodes the image data, and stores the image data in the image-code storing unit for processing. Accordingly, the efficiency of encoding and decoding of the image can be improved.

Furthermore, according to the image processing apparatus of one embodiment of the present invention, the intermediate-language creating unit creates a drawing command and an encoding command. Accordingly, there is no interrupt processing for drawing termination, and hence, the system efficiency is improved.

Moreover, according to the image processing apparatus of one embodiment of the present invention, it is determined whether the command is for reading the intermediate language from the intermediate-language storing unit to create image data or for encoding, thereby enabling processing according to the sequence of the processing command at the time of drawing. Accordingly, the system efficiency is improved.

The image processing apparatus according to one embodiment of the present invention creates the image data according to the analyzed image data creation command, and hence, the processing efficiency is improved at the time of creating the image data.

Furthermore, according to the image processing apparatus of one embodiment of the present invention, since the encoded data is created according to the encoding command analyzed by the intermediate-language analyzing unit, the encoding efficiency is improved.

According to the image processing method of one embodiment of the present invention, the intermediate language is analyzed, the completion of the processing by the image-data creating unit that creates the image data is recognized, and the encoding unit that encodes the image data is activated, thereby serially controlling the band creation and compression processing of the band. Accordingly, memory contention between the drawing processing and the encoding processing can be avoided, thereby improving the system efficiency.

The computer readable recording medium according to one embodiment of the present invention has an effect that since the program for making a computer execute the image processing method is recorded on the computer readable recording medium, the image processing can be executed on the computer.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. An image processing apparatus comprising:
an intermediate-language creating unit to analyze a page description language to create an intermediate language having information of all CMYK printing versions;
an intermediate-language storing unit to store the intermediate language created;
a drawing-version setting unit to set each of the CMYK printing versions to be drawn with the intermediate language;
an image-data creating unit to analyze the intermediate language stored to create image data for at least one printing version for creating the image data;
an image-data storing unit to store the image data created; and
a drawing-version control unit to recognize the printing version to be drawn set by the drawing-version setting unit, and to read the intermediate language stored for a plurality of times.

2. The image processing apparatus according to claim 1, wherein the image-data creating unit includes a drawing-command-address generating unit to generate a top address of a drawing command in the intermediate language stored.

3. The image processing apparatus according to claim 2, wherein the drawing-command-address generating unit includes an intermediate-language-top-address storing unit to store the top address of the intermediate-language storing unit.

4. The image processing apparatus according to claim 1, wherein the image-data creating unit includes a drawing-command-size generating unit to analyze a drawing command in the intermediate language read from the intermediate-language storing unit to obtain a size of each of the drawing commands.

5. An image processing apparatus comprising:
an intermediate-language creating unit to analyze a page description language to create an intermediate language in the unit of band or in the unit of page;
an intermediate-language storing unit to store the intermediate language;
an image-data creating unit to analyze the intermediate language stored to create image data for at least one printing version for creating the image data in the unit of band or in the unit of page;
an image-data storing unit to store the image data;
an image-data encoding unit to encode the image data stored in the unit of band or in the unit of page to create an image-data code;
an image-data-code storing unit to store the image-data code;
an image-data decoding unit to decode the image-data code;
a drawing-state storing unit to inform the intermediate-language creating unit of a drawing state, the drawing state including an active state in which drawing is being performed and a suspended state in which the drawing is being suspended; and
a parallel-operation control unit to obtain a state of the image-data creating unit from the drawing-state storing unit to control a parallel operation of the intermediate-language creating unit and the image-data creating unit.

6. An image processing method comprising:
analyzing a page description language to create an intermediate language having information of all CMYK printing versions;
storing the intermediate language;
setting each of the CMYK printing versions to be drawn with the intermediate language;
analyzing the intermediate language stored to create image data for at least one printing version for creating the image data;
storing the image data;
recognizing the printing version to be drawn set; and
reading the intermediate language stored for a plurality of times.

7. An image processing apparatus comprising:
an intermediate-language creating unit to analyze a page description language to create an intermediate language;
an intermediate-language storing unit to store the intermediate language created;
an image-data creating unit to analyze the intermediate language stored to create image data;
an image-data storing unit to store the image data created;
an encoding unit to encode the image data stored to create an image code;
an image-code storing unit to store the image code created; and
a processing control unit to recognize a completion of processing of the image-data creating unit, and to activate the encoding unit.

8. The image processing apparatus according to claim 7, wherein the processing control unit includes an intermediate-language-creation halting unit to inform the intermediate-language creating unit of the completion of processing of the image-data creating unit to halt processing.

9. The image processing apparatus according to claim 7, wherein the intermediate-language storing unit stores at least the intermediate language being processed by the image-data creating unit.

10. An image processing apparatus comprising:
an intermediate-language creating unit to analyze a page description language to create an intermediate language;
an intermediate-language storing unit to store the intermediate language;
an image processing unit to analyze the intermediate language stored to create image data, and to encode the image data to create an image code;
an image-data storing unit to store the image data created; and
an image-code storing unit to store the image code created.

11. The image processing apparatus according to claim 10, wherein the intermediate-language creating unit creates a drawing command and an encoding command.

12. The image processing apparatus according to claim 10, further comprising an intermediate-language analyzing unit to read the intermediate language from the intermediate-language storing unit to determine whether the intermediate language is an image-data creating command or an encoding command.

13. The image processing apparatus according to claim 10, further comprising an image-data creating unit to create image data according to an image-data creating command analyzed by the intermediate-language analyzing unit.

14. The image processing apparatus according to claim 10, further comprising an encoding unit to create coding data according to an encoding command analyzed by the intermediate-language analyzing unit.

15. An image processing method comprising:
analyzing a page description language to create an intermediate language;
storing the intermediate language;
analyzing the intermediate language stored to create image data;
storing the image data;
encoding the image data stored to create an image code;
storing the image code;
recognizing a completion of processing of the analyzing the intermediate language; and
activating the encoding.

16. A computer-readable recording medium that stores a computer program having instructions which when executed cause a computer to perform a method comprising:
analyzing a page description language to create an intermediate language having information of all CMYK printing versions;
storing the intermediate language;
setting each of the CMYK printing versions to be drawn with the intermediate language;
analyzing the intermediate language stored to create image data for at least one printing version for creating the image data;
storing the image data;
recognizing the printing version to be drawn set; and
reading the intermediate language stored for a plurality of times.

17. A computer-readable recording medium that stores a computer program having instructions which when executed cause a computer to perform a method comprising:
analyzing a page description language to create an intermediate language;
storing the intermediate language;
analyzing the intermediate language stored to create image data;
storing the image data;
encoding the image data stored to create an image code;
storing the image code;
recognizing a completion of processing of the analyzing the intermediate language; and
activating the encoding.
